(19) United States
(12) Patent Application Publication
(10) Pub. No.: US 2017/0071235 A1
(43) Pub. Date: Mar. 16, 2017

(54) A METHOD FOR TRICHOTHECENE DETOXIFICATION

(71) Applicant: VETERINÆRINSTITUTTET, Oslo (NO)

(72) Inventors: Ana STANIC, Oslo (NO); Silvio UHLIG, Oslo (NO); Christopher Owen MILES, Oslo (NO)

(73) Assignee: VETERINÆRINSTITUTTET, Oslo (NO)

(21) Appl. No.: 15/309,011

(22) PCT Filed: May 6, 2015
(86) PCT No.: PCT/EP2015/059939

§ 371 Date: Nov. 4, 2016

(30) Foreign Application Priority Data
May 6, 2014 (NO) 20140585

(51) Int. Cl. A23L 5/20; A23K 50/10; A23K 20/10; A23K 50/80; A23K 10/30

(52) U.S. Cl. CPC A23L 5/27; A23K 50/80; A23K 10/30; A23K 20/10; A23K 50/10; A23V 2002/00

(57) ABSTRACT

The present document is directed to detoxification of trichothecenes using a method involving trichothecene epoxide ring opening. In particular, the present document discloses the detoxification of a trichothecene by reaction with a thiol containing compound under conditions where the pH is equal to or higher than one pH unit less than the pKa of a thiol group of the thiol containing compound.

### TECHNICAL FIELD

The present document pertains to the detoxification of a trichothecene contaminated sample, such as a type A and/or type B trichothecene contaminated sample. More specifically, the present document pertains to a method for detoxification of a trichothecene, such as a type A and/or type B trichothecene, contaminated sample by reaction with a thiol under alkaline conditions.

### BACKGROUND

Trichothecene mycotoxins are a large family of chemically related mycotoxins that are toxic to humans, animals, plants and eukaryotic cells in general. The trichothecenes may be produced on different grains, such as wheat, oats or maize, by fungi and molds such as Fusarium, Myrothecium, Trichoderma, Trichothecium, Cephalosporium, Verticimonosporium, and Stachybotrys. When trichothecenes are present in, for instance, food or agricultural products, they lead to severe health problems for humans and animals. The toxicity varies depending on the particular trichothecene mycotoxin but common major effects are reduced feed uptake, vomiting and immuno-suppression.

Fusarium toxins can occur in many types of human and animal food, including cereal grains such as barley, oats, rice, rye, teff, triticale, wheat, wild rice, finger millet, fonio, foxtail millet, Kodo millet, Japanese millet, Job's Tears, maize (corn), pearl millet, proso millet and sorghum.

Toxins have also been found in hay, flax, peas, soy, rapeseed and other oilseeds such as sunflower, hemp and poppy. Trichothecene toxins may also occur in other types of food, e.g. in beets that are grown on a field where previous crop residues are plowed into the soil. Thus, while this disclosure mainly uses cereal grains as examples, it is also applicable to food or feed composed of any ingredients contaminated with Fusarium toxins.

Hazardous concentrations of trichothecene mycotoxins may occur naturally in moldy grains, cereals or agricultural products. The problem has been reported to occur all over the world. For instance, in the former Soviet Union more than 10% of the population in Orenburg were afflicted by alimentary toxic aleukia, a disease apparently caused by consuming grain infested with Fusarium that was contaminated with the trichothecene T-2 toxin. In Japan, trichothecenes have been found to be involved the so-called red mold disease of wheat and barley and also in infected rice. The disease stachybotryotoxicosis caused by the trichothecene satratoxin has been reported among farm workers in Russia, former Yugoslavia and Hungary. In addition, ingestion of moldy grain has been associated with mycotoxicosis in domestic farm animals.

The toxicity of the trichothecene mycotoxins in combination with their ease of formation in plants, cereals and agricultural products and possible use in biological weapons has prompted researchers to investigate their structure, biological activity and also ways of performing detoxification.

Trichothecenes are sesquiterpenoid compounds and have the general structure shown in FIG. 1. Frequently, the trichothecenes are divided into four types (A-D) according to structural similarities. However, only type A-trichothecenes and type B-trichothecenes (FIG. 1) are of relevance in agriculture. One of the most extensively studied trichothecenes is the type A-trichothecene T-2 toxin, which possesses an acetyl ester function at R₁ (FIG. 1). Important type B-trichothecenes include deoxynivalenol (commonly abbreviated DON and/or called vomitoxin) and nivalenol (commonly abbreviated NIV). In deoxynivalenol the R₁, R₃ and R₄ substituents are hydroxyl groups and R₂ is hydrogen. In nivalenol, the R₁, R₂, R₃ and R₄ substituents are hydroxyl groups. Thus, the chemical structure for deoxynivalenol and nivalenol differ inter alia in that the R₂ substituent is hydrogen in deoxynivalenol while it is a hydroxyl group in nivalenol.

There are also macrocyclic trichothecenes (type D trichothecenes) in which the R₂ and R₃ groups are connected via an ester group. Examples of macrocyclic trichothecenes include verrucarins, roridins, and satratoxin.

The trichothecene mycotoxins are nonvolatile, low molecular weight compounds that are generally relatively soluble in water as well as in many organic solvents such as acetone, ethyl acetate, chloroform, dimethyl sulfoxide and ethanol.

In the textbook Medical Aspects of Biological Warfare, it is reported that trichothecene mycotoxins are stable to air and light or a combination thereof. It is said that inactivation may be achieved by heating to 260 or 480 degrees Celsius for 10 and 30 minutes, respectively. Alternatively, inactivation may be achieved by exposure to a 3 to 5% solution of sodium hypochlorite. The efficacy is enhanced by adding small amounts of alkali, but higher concentrations of alkali or acid do not destroy trichothecene activity. It is stated that high pH environments are ineffective for inactivating trichothecene mycotoxins.

Additionally, exposure of trichothecenes to high pH is known to cause isomerization and/or degradation of the trichothecene molecule.

The principal structural feature associated with trichothecene toxicity is the epoxy ring between the carbon atoms C12-C13. The epoxide is known to be relatively chemically unreactive and stable. Chemical detoxification of trichothecenes therefore usually involves reaction of the 9,10 double bond.

Appl. Microbiol. Biotechnol., August 2011, 91(3), 491-504 discloses that the epoxide of trichothecenes may be destructed by reductive de-epoxidation and hydrolytic de-epoxidation. It is also mentioned that nucleophilic attack of the epoxide may take place by thiols in plants. However, supporting evidence is missing. Use of enzymatic catalysis was reported to fail.

In Biochemical Society Transactions, 1975, Vol. 3, 875-878, Foster et al. disclose a method based on allowing glutathione to react to the epoxide moiety of a trichothecene mycotoxin in the presence of glutathione S-epoxidetransferase in order to assess the amount of mycotoxin in a sample.

In Molecular Plan-Microbe Interactions, Vol. 23, No. 7, 2010, pp. 962-976, Gardiner et al. report that RNA profiling of DON-treated barley spikes showed strong upregulation of gene transcripts encoding glutathione-S-transferases and cysteine synthases. An NMR spectroscopic investigation was performed on a sample prepared by dissolving DON and glutathione (GSH) in D₂O at pH8. However, no DON epoxide ring opening was observed.

Org. Biomol. Chem., 2014, 12, 5144-5150 discloses Michael addition of methane thiol to the conjugated double bond of DON. Reaction of thiomethoxide (NaSMe) with DON according to a procedure described in U.S. Pat. No. 8,101,803 B2 showed no conversion of starting materials. However, a method using methyl iodide (Mel) and thiourea in wet polyethylene glycol resulted in Michael addition of methyl thiol to DON thereby forming methylthiodeoxynivelanol (MTD) as a hemiketal and in open form, respectively.

Thus, contamination by trichothecene mycotoxins is a worldwide problem necessitating destruction and disposal of large amounts of agriculturally related products such as grains and cereals every year. Since preventive measures will not be sufficient or practically viable to stop the occurrence of trichothecene mycotoxins it would be desirable to find a method for detoxifying samples such as agricultural products before they reach consumers. In particular, such a detoxification method should be suitable for performance on a large scale to allow for treatment of the often very large quantities of the trichothecene contaminated samples.

It is an object of the present invention to overcome or at least mitigate some of the problems associated with the prior art.

### SUMMARY

One object of the present document is to provide a method for detoxification (inactivation) of trichothecenes, in particular type A and/or type B trichothecenes.

This object is obtained by the present disclosure which discloses a method for detoxification of a trichothecene, in particular a type A and/or type B contaminated sample, wherein the method comprises the step of reacting said type A and/or type B trichothecene contaminated sample with a thiol containing compound under acidic, neutral or alkaline conditions. The acidic, neutral or alkaline conditions may be provided by an aqueous solution, i.e. a solution comprising or consisting of water, where the pH has been adjusted to be acidic, neutral or alkaline. The pH of the reaction may be selected so that it is up to one pH unit less than the pKa of a thiol group of the thiol containing compound. Exemplary type A and/or type B trichothecenes to be detoxified are deoxynivalenol, nivalenol, T-2 toxin and/or HT-2 toxin.

The present document is thus directed to a method for detoxification of a trichothecene contaminated sample, said method comprising the steps of:
a) mixing said trichothecene contaminated sample, a thiol containing compound, and an aqueous solution thereby providing a reaction mixture;
   wherein said reaction mixture has a pH that is equal to or higher than one pH unit less than the pKa of a thiol group of said thiol containing compound;
b) allowing the reaction to proceed.

In particular, detoxification comprises epoxide ring opening of the type A and/or type B trichothecene. Opening of the epoxide ring leads to a reduction or abolishment of the toxic activity of the trichothecene. Detoxification may further comprise Michael addition to the 9,10 double bond of the type A and/or type B trichothecene.

The acidic, neutral or alkaline conditions used during the reaction may be provided by a strong or a weak base. Exemplary weak bases for use according to the present document include, but are not limited to, carbonates, borates and amines. Exemplary strong bases include, but are not limited to, bases selected from the group consisting of sodium hydroxide or potassium hydroxide.

The reaction is allowed to proceed for a time period sufficient for the detoxification reaction to take place to reduce the amount of trichothecene toxin in a sample to an acceptable level, such as a level acceptable for consumption by humans and/or animals. In some instances, it is possible to allow the reaction to proceed during normal processing of a sample. For example, the detoxification reaction may proceed for from about one hour to one month, such as from about 4 to about 7 days.

The reaction may take place at ambient temperature, such as room temperature. Also, it may be possible to perform the reaction at elevated temperatures, such as temperatures commonly employed in food and feed production. These may e.g. be from about 30° C. to about 85° C.

The detoxification reaction may for example be performed at a pH of about 8 or above, such as a pH range from about 8 to about 11.5 or from about 10 to about 11. Alternatively, the pH may be neutral, i.e. substantially 7, or acidic, i.e. below 7.

The thiol containing compound may be any thiol containing compound. The thiol containing compound may be selected so that the thiol containing compound has a pKa from 6.5 to 10, such as from 7 to 10 or such as from 8 to 10. Exemplary thiol containing compounds may be selected from one or more from the group consisting of: mercaptoethanol, cysteine, aminoethanethiol, thioethanesulfonate and glutathione. Further examples of thiol containing compounds include hydrogen sulfide and methane thiol.

The sample contaminated with a trichothecene, such as a type A and/or type B trichothecene, may be any kind of trichothecene contaminated sample. Exemplary samples include, but are not limited to, agricultural product such as hay or straw, grains or seeds, flour and other milled products, and livestock or fish feed. The sample may e.g. be a grain-derived or grain-containing product, such as grain intended for food or feed production.

The present document is also directed to the use of a thiol containing compound for detoxification of a trichothecene, such as a type A and/or type B trichothecene, contaminated sample by epoxide ring opening of the trichothecene. The thiol containing compound is as defined elsewhere herein

The present document is also directed to a kit of parts comprising a thiol containing formulation and a strong or weak base in the same container, and instructions for use involving detoxification. The present document is also directed to a kit of parts comprising a thiol containing formulation and a weak base in separate containers, and optionally instructions for use involving detoxification. The thiol containing compound of the thiol containing formulation and the strong or weak base are as defined elsewhere herein.

The present document is also directed to a product obtainable by a method for detoxification of a trichothecene contaminated sample as disclosed herein.

The present document is also directed to the use of a thiol containing compound for detoxification of a trichothecene contaminated sample by epoxide ring opening of said trichothecene.

Other features and advantages of the invention will be apparent from the following detailed description, drawings, examples, and from the claims.

### DEFINITIONS

“Detoxification”, “detoxified” and the like refers in the context of the present document to a reduction or abolishment of the toxic effects of a substance. In the context of the present document, “inactivation”, “inactivated” and the like may be used analogously with “detoxification”, detoxified” etc.

A “type A and/or type B trichothecene” is a type of sesquiterpene mycotoxins, which inhibit protein synthesis. The biological activity of trichothecenes is mainly governed by the 12,13-epoxy ring, and secondarily, the presence of hydroxyl or acetyl groups and the structure and position of the side-chain at C8 (FIG. 1). Examples of type A trichothecenes (FIG. 1, compound 1) include T-2 toxin, HT-2 toxin, and diacetoxyscirpenol. Examples of type B trichothecenes (FIG. 1, compound 2) include deoxynivalenol (DON), nivalenol (NIV), and 3- and 15-acetyldeoxynivalenol. Trichothecenes are produced by fungi such as of the Fusarium genus, including F. graminearum, F. sporotrichioides, F. poae and F. equiseti on grains such as oats, maize, rye, rice, sorghum and wheat. In the context of the present document by “type A and/or type B trichothecene” is intended a trichothecene of one of the general formulas of FIG. 1.

By “trichothecene contaminated sample” is in the context of the present document intended any kind of sample containing one or more different kinds of a trichothecene toxin, such as a type A, type B, type C and/or type D trichothecene toxin.

By “thiol containing compound” is in the context of the present document intended any compound containing a thiol group, i.e. a carbon-bonded sulfhydryl (—C—SH or R—SH) group (R representing an alkane, alkene, or other carbon-containing group of atoms). The thiol containing compounds employed in the context of the present document are in particular thiol containing compounds which are non-toxic in the amounts used in the present context. A “thiol containing compound” may in the context of the present document also be denoted a “thiol”.

By “alkaline conditions” is in the present context intended conditions which have a pH higher than 7, in particular about 8 or above, such as from about 8 to about 11.5, from about 8 to about 10, from about 9 to about 11.5, from about 9 to about 11 or from about to about 11.

By “neutral conditions” is in the present context intended conditions which have a pH equal to 7 or substantially equal to 7.

By “acidic conditions” is in the present context intended conditions which have a pH less than 7.

As used herein, an aqueous solution is a solution comprising or consisting of water. The water of the aqueous solution is preferably ordinary water (H₂O) and not deuterated water (D₂O).

By “strong base” is in the context of the present document intended a base which has a pKa value (i.e. the pKa value of the conjugate acid of the base) equal to or above 11. A strong base generally has a pKb of 13 or more. Exemplary strong bases include alkali metal hydroxides of alkali metals such as sodium hydroxide and potassium hydroxide.

By “weak base” is in the context of the present document intended a base which has a pKa value (i.e. the pKa value of of the conjugate acid of the base) from about 7 to about 11. Exemplary weak bases include carbonates, borates and amines, such as alkali metal salts of carbonic acid and boric acid such as sodium carbonate, sodium borate and ammonium bicarbonate.

### ABBREVIATIONS

COSY Correlation Spectroscopy
GC Gas Chromatograpy
ESI Electrospray Interphase
ELISA Enzyme-Linked Immunosorbent Assay
HPLC High Performance Liquid Chromatography
HSQC Heteronuclear Single Quantum Coherence
JMOD J-Modulated Spin-Echo
LC-MS Liquid Chromatography-Mass Spectroscopy
LC-HRMS Liquid Chromatography-High Resolution Mass Spectrosopy
MS Mass Spectrosopy
NOESY Nuclear Overhauser Effect Spectroscopy
NMR Nuclear Magnetic Resonance
ROESY Rotating frame nuclear Overhauser effect spectroscopy
TOCSY Total Correlation Spectrosopy

### BRIEF DESCRIPTION OF THE DRAWINGS

FIG. 1. The structure of type A trichothecenes with examples of important analogues (1), type B trichothecenes with examples of important analogues (2), (3) and (4). Abbreviations are OAc=acetyl ester, OⁱVal=isovaleryl ester.

FIG. 2. Reaction of deoxynivalenol (5.06 mM) with mercaptoethanol (7.10 mM) in a 200 mM carbonate buffer (pH 10.7) (t₁=4 days). The reaction product mixture consists of mono- and di-conjugated deoxynivalenol derivatives (1 and 2, respectively).

FIG. 3. Effect of pH on the half-life of deoxynivalenol (5.06 mM) during reaction with mercaptoethanol (7.10 mM).

FIG. 4. Structures of deoxynivalenol (top left) as well as identified products from reaction with mercaptoethanol.

FIG. 5 shows a chromatogram of how tricothecenes are detoxified using mercaptoethanol.

FIG. 6 shows a graph of disappearance of DON as a function of time and pH upon reaction with mercaptoethanol.

FIG. 7 shows products resulting from reaction of DON and mercaptoethanol.

FIG. 8 is a graph showing effects of DON, deepoxy-DON, compounds 1a/1b and compounds 2a/2b on proliferation of THP-1 monocytes.

FIG. 9. Graph A shows effects of DON, deepoxy-DON, compounds 1a/1b and compounds 2a/2b TNF-α secretion produced by PMA-differentiated macrophages, with and without LPS priming. Graph B shows effects of DON, deepoxy-DON, compounds 1a/1b and compounds 2a/2b TNF-α secretion produced by PMA-differentiated macrophages, with and without LPS priming.

### DESCRIPTION

The present document is directed to the detoxification of trichothecenes, such as type A, type B, type C and/or type D trichothecenes. Albeit the method or use described herein may refer to the detoxification of type A and/or type B trichothecenes only, it will be appreciated that the method or use described herein is intended for type A, type B, type C and/or type D trichothecenes. In particular, the present document is directed to a method for detoxification of a trichothecene-contaminated sample, such as a type A and/or type B trichothecene contaminated sample, such as a grain-derived or grain-containing sample, wherein the method comprises the step of reacting the type A and/or type B trichothecene contaminated sample with a thiol-containing-compound under acidic, neutral or alkaline conditions. The acidic, neutral or alkaline conditions may be provided by an aqueous solution, said aqueous solution having a pH that is acidic, neutral or alkaline. The pH of the aqueous solution or in the reaction mixture may be selected so that it is equal to or higher than one pH unit less than the pKa of a thiol group of the thiol containing compound (i.e. the pH is ≧pKa-1). For instance, if a thiol group of the thiol containing compound has a pKa of about 9 then the pH of the aqueous solution may be selected to be about 8 or above, such as about 8.5 or above or 8.8 or above. The pH may also be selected to be equal to or higher than one half pH unit less than the pKa of a thiol group of the thiol containing compound (i.e. pH is ≧pKa-0.5). The pH may also be selected to be equal to or higher than the pKa of a thiol group of the thiol containing compound (i.e. pH is ≧pKa). It is important that the pH is ≧pKa-1 of a thiol group of the thiol containing compound used in the reaction in order to ensure a sufficient reaction rate. A higher pH generally results in a higher reaction rate. However, the actual pH used in a reaction has to be selected also taking the type of sample to be detoxified into account in order to ensure that the sample is still useful for its purpose after the detoxification has taken place as further explained elsewhere herein.

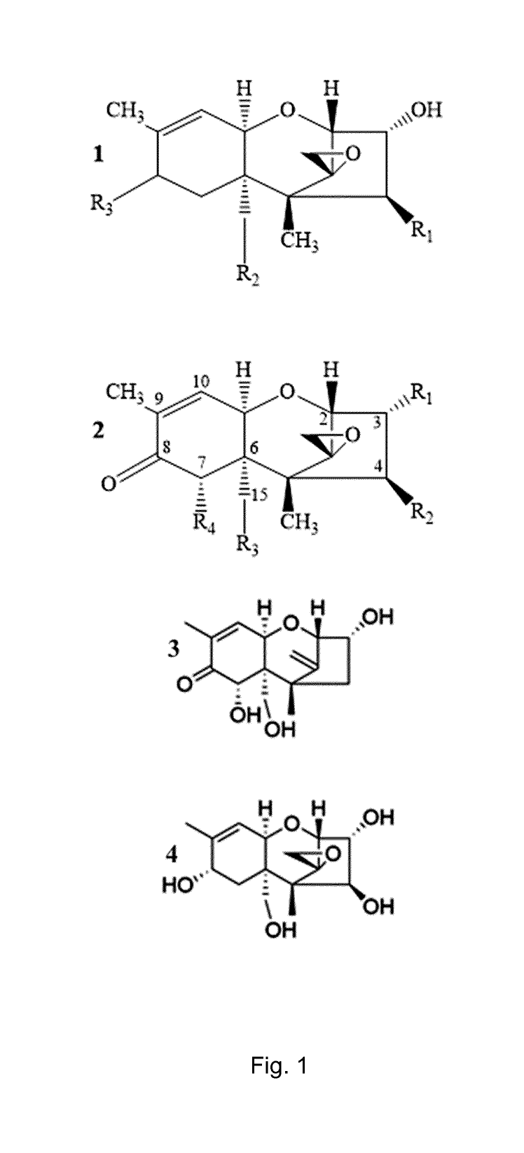

Examples of trichothecenes that may be subjected to the reaction conditions of the method described herein are illustrated in FIG. 1. The trichothecene in FIG. 1 with the compound numbering 1 may have the substituents as indicated in Table 1. Further, the trichothecene in FIG. 1 with the numbering 2 may have the substituents as indicated in Table 2.

TABLE 1

| Compound name | R₁ | R₂ | R₃ |
|---|---|---|---|
| T-2 toxin | OAc | OAc | OⁱVal |
| HT-2 toxin | OH | OAc | OⁱVal |
| 15-acetoxy- | OH | OAc | H |
| scirpenol | | | |
| 4,15-acetoxy- | OAc | OAc | H |
| scirpenol | | | |
| neosolaniol | OAc | OAc | OH |
| isoneosolaniol | OAc | OH | OAc |

TABLE 2

| Compound | | | | |
|---|---|---|---|---|
| name | R₁ | R₂ | R₃ | R₄ |
| 4- | OH | H | OH | OH |
| deoxynivalenol | | | | |
| (DON) | | | | |
| nivalenol | OH | OH | OH | OH |
| fusarenon-X | OH | OAc | OH | OH |
| 3-acetyl-DON | OAc | H | OH | OH |
| 15-acetyl-DON | OH | H | OAc | OH |
| 3,7,15-acetyl- | OAc | H | OAc | OAc |
| DON | | | | |

Thus, there is provided a method for detoxification of a trichothecene contaminated sample, said method comprising the steps of:
a) mixing said trichothecene contaminated sample, a thiol containing compound, and an aqueous solution thereby providing a reaction mixture;
   wherein said reaction mixture has a pH that is equal to or higher than one pH unit less than the pKa of a thiol group of said thiol containing compound;
b) allowing the reaction to proceed.

The present document is also directed to the use of a thiol-containing-compound as defined herein for detoxification of a trichothecene contaminated sample, such as a type A and/or type B trichothecene contaminated sample, by epoxide ring opening of the trichothecene.

The present disclosure also concerns products resulting from addition of a thiol containing compound to trichothecenes. When a thiol containing compound of formula RSH is added to DON compounds of formula 5a, 5b, 5c, 5d, 5e and 5f may be formed. DON may exist in keto form (2a) or in hemiketal form (2b). It will be appreciated that compounds of formula 5c, 5d, 5e and 5f may exist as four isomers. The reaction between RSH and DON is outlined in Scheme 1. As described herein, a long reaction time favours formation of the DON epoxide ring opened products 5a and 5b while a short reaction time favours formation of the Michael addition products 5c and 5d. Compounds of formula 5e and 5f are compounds which have undergone both Michael addition and addition to the epoxide of RSH. RSH may be any thiol containing compound as described in this document. For instance, RSH may be cysteine or glutathione. In particular, compounds of formula 5a and 5b are provided.

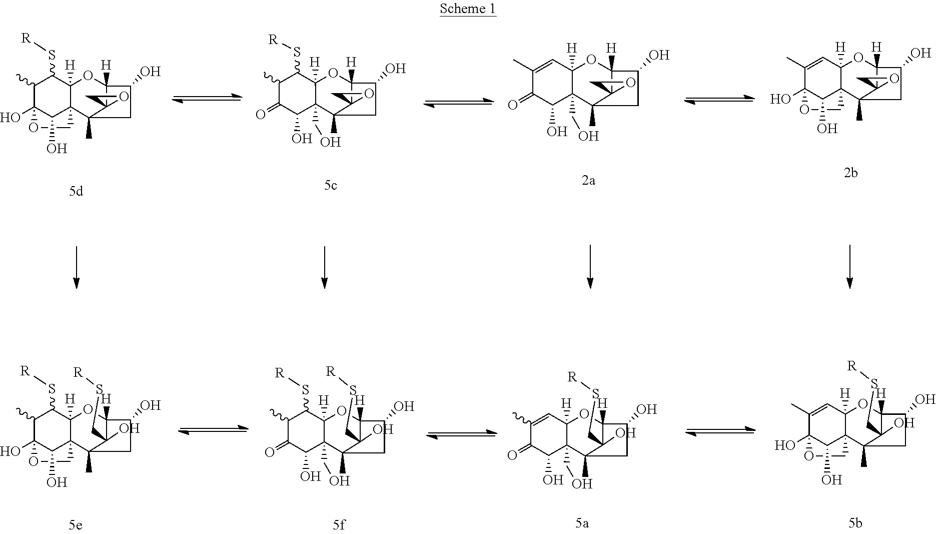

Thus, the present disclosure is also directed to products obtainable by the method described herein. For instance, the products may be compounds of formula 5a, 5b, 5c, 5d, 5e and 5f. of formula 5a, 5b, 5c or 5d below. As described herein, 5a and/or 5b will form predominantly as time evolves. As an example, the products obtainable by the method described herein may be compounds of formula 5a and 5b.

The present document is also directed to a kit of parts comprising a thiol-containing formulation comprising a thiol containing compound as defined herein and a strong or a weak base as defined herein in the same container, and instructions for use involving detoxification of a trichothecene contaminated sample, such as a type A and/or type B trichothecene contaminated sample.

The present document is further directed to a kit of parts comprising a thiol-containing formulation comprising a thiol containing compound as defined herein and a strong or a weak base as defined herein in separate containers and optionally instructions for use involving detoxification of a trichothecene contaminated sample, such as a type A and/or type B trichothecene contaminated sample.

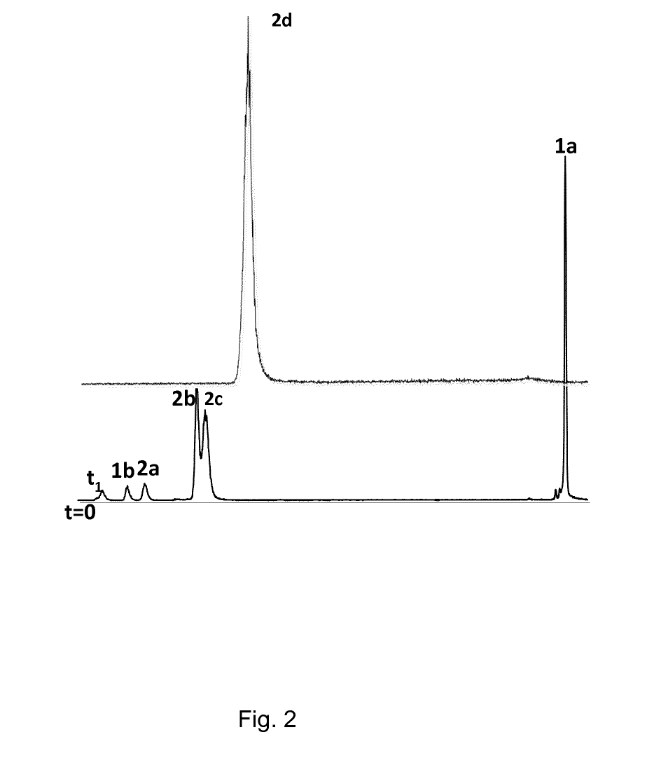

The present inventors have surprisingly found that it is possible to detoxify a trichothecene, such as a type A and/or type B trichothecene, by non-enzymatic reaction of the epoxide ring of the trichothecene with a thiol containing compound under alkaline conditions (see FIG. 2 referred to in the experimental section). The epoxide ring is one of the structural features linked to trichothecene toxicity. However, the epoxide ring is also known to be relatively non-reactive. It was therefore highly unexpected to find that detoxification of a type A and/or type B trichothecene could be achieved by reacting the non-reactive epoxide ring with a thiol containing compound under the acidic, neutral or alkaline conditions disclosed herein (FIGS. 2, 3 and 4 referred to in the experimental section).

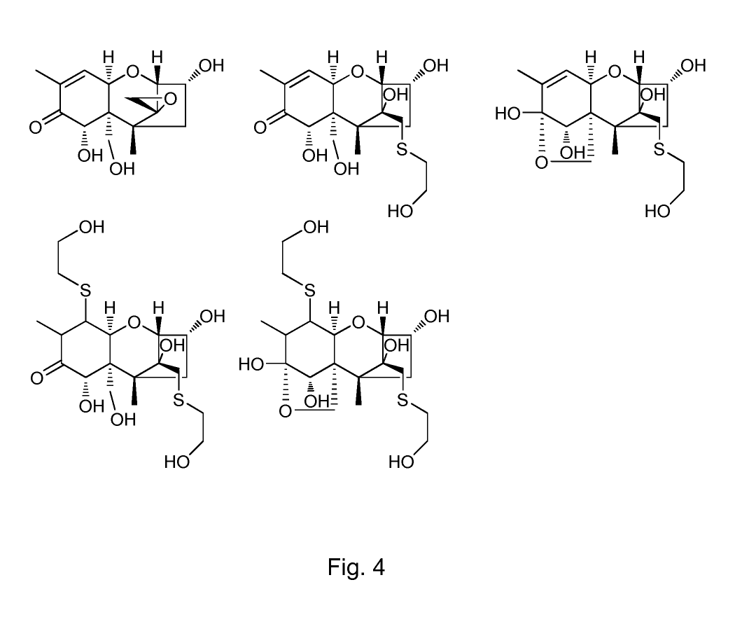

Accordingly, there is provided a non-enzymatic (i.e. chemical) method or use for detoxification of trichothecene, such as a type A and/or type B trichothecene. The type A and/or type B trichothecenes may be contained in a sample such as grains, cereals and/or agricultural products. In the detoxification of type A and/or type B trichothecenes as described herein, opening of the epoxide ring is of particular interest and the detoxification according to the present document is to a significant extent due to such epoxide ring opening by conjugation to a thiol containing compound under acidic, neutral or alkaline conditions (FIGS. 2 and 4). However, the epoxide is relatively unreactive and stable making transformations thereof difficult. As the type C and D trichothecenes share the epoxide ring structure with the type A and B trichothecenes, the reaction disclosed in the present document may also be used for detoxification of type C and/or type D trichothecenes.

Despite the expected non-reactivity of the epoxide ring of the trichothecene toxins, the inventors surprisingly have achieved detoxification of type A and/or type B trichothecenes by selective epoxide ring opening using a thiol at conditions where the pH of the reaction mixture is equal to or higher than one pH unit less than the pKa of a thiol group of the thiol containing compound used in the reaction (FIGS. 2, 3 and 4). As used herein, selective epoxide ring opening in the context of trichothecenes means that the epoxide ring reacts with the thiol to an equal or a larger extent than reaction with the 9,10 double bond in a sample, in particular over time. Michael addition of the thiol to the conjugated double bond of the trichothecene takes place faster than thiol addition to the sterically hindered trichothecene epoxide. However, the Michael addition is reverible while thiol addition to the sterically hindered trichothecene epoxide take place irreversibly. Therefore, over time more epoxide ring opening takes place and the overall result is formation of epoxide adduct together with little or no Michael addition adduct. The ratio of epoxide adduct/Michael addition adduct will increase over time so that a longer reaction time favours the formation of epoxide adduct. For example, all or essentially all of the epoxide in a tricothecene sample may be conjugated, such as when mercaptoethanol is used as a thiol (FIG. 2). This selectivity in favour of the epoxide ring opening reaction is a significant benefit since the trichothecene epoxide to a large extent accounts for the toxicity

Examples of (detoxified) products resulting from the reaction with deoxynivalenol with mercaptoethanol are given in FIG. 4. As the presence of the epoxide group has an important impact on the toxicity of trichothecenes, the reaction of a thiol containing compound with any type A and/or type B trichothecenes can be applied for non-enzymatic (i.e. chemical) detoxification of contaminated feeds or food.

The reaction trichothecenes, such as type A and/or type B tricothecenes, with a thiol containing compound as described herein, i.e. a non-enzymatic or chemical reaction performed in vitro, effectively reduces or abolishes the toxicity of the type A, type B, type C and/or type D trichothecene. Previous attempts to non-enzymatically (i.e. chemically) detoxify, in particular, type A and/or type B trichothecenes have not been successful, in particular when intended for use in larger scale. In contrast, the reaction of the present document is easy to use in larger scale, such as for industrial use, due to inter alia the moderate temperature (e.g. room temperature) that may be used. Thus, the method described herein may be a preparative method or an industrial method. As used herein, a preparative method intends a method for production of milligram or gram quantities of detoxified type A, B, C or D trichothecenes. As used herein, an industrial method intends a method involving production of kilograms or tons of type A, B, C or D trichothecenes. Further, the method described herein may be performed in an atmosphere comprising or consisting of air. Alternatively, the method described herein may be performed under inert atmosphere such as an atmosphere comprising or consisting of argon, nitrogen, carbon dioxide or mixtures thereof.

The type A and/or type B trichothecenes to be detoxified according to the present document may be any kind of type A or type B trichothecenes. In particular, the type A or type B trichothecenes are characterized by their 12,13-epoxy ring and 9,10 double bond, which have also been linked to their toxicity. Examples of type A trichothecenes include, but are not limited to T-2 toxin, HT-2 toxin, and diacetoxyscirpenol. Exemplary type B trichothecenes include, but are not limited to deoxynivalenol (DON, vomitoxin), nivalenol (NIV), 3- and 15-acetyldeoxynivalenol. A type A and/or type B trichothecene contaminated sample may comprise one or more of a type A and/or type B trichothecene toxin. In particular, the type A and/or type B trichothecene is DON, NIV, T-2 toxin and/or HT-2 toxin.

The detoxification reaction as described herein may take place at an acidic, neutral or alkaline pH provided that the pH is equal to or higher than one pH unit less than the pKa of a thiol group of the thiol containing compound used. The acidic, neutral or alkaline pH may be provided by an aqueous solution. The aqueous solution may comprise or consist of water. The aqueous solution may be a mixture of water and an organic solvent such as a water miscible organic solvent. The water miscible solvent may be an alcohol such as ethanol. The alkaline pH may be achieved by use of any kind of base, such as a strong or a weak base. Exemplary weak bases include, but are not limited to, weak bases selected from the group consisting of carbonates, borates and amines, including alkali metal salts of carbonic acid and boric acid (e.g. sodium carbonate and sodium borate), and ammonium carbonate. The most common salt of the bicarbonate ion is sodium bicarbonate, NaHCO₃, which is commonly known as baking soda. Other salts are potassium bicarbonate, calcium bicarbonate and ammonium bicarbonate, known as “sal volatile” or salt of hartshorn. These are all known to be used as ingredients in food industry, or being naturally present. Also, ammonia could be as a solution of NH₃ in water (i.e., ammonium hydroxide) that also may be used to reduce or eliminate microbial contamination. The strong base may comprise or consist of a hydroxide. Exemplary strong bases include, but are not limited to, strong bases selected from the group consisting of sodium hydroxide, ammonium hydroxide and potassium hydroxide. It is also possible to use two or more of a weak and/or a strong base for adjusting the pH.

The pH of the reaction mixture may be preferably selected to be equal to or higher than one pH unit less than the pKa of a thiol group of the thiol containing compound (i.e. pH is ≧pKa-1), equal to or higher than 0.5 pH units less than the pKa of a thiol group of the thiol containing compound used (i.e. pH is ≧pKa-0.5), or equal to or higher than the pKa of a thiol group of the thiol containing compound used (i.e. pH is ≧pKa). E.g. if the pKa of the thiol is 8, the pH is preferably selected to be 7 or more. As known in the art, the pKa is the pH at which an acid is half way ionized (i.e. the pH at which the concentration of thiolate and thiol are equal). A higher pH drives the equilibrium reaction between a thiol and a base towards more thiolate to form and thus the reaction is faster at a higher pH, independently of the thiol used. However, for food and feed products, it is also important to select a pH to work at that does not render the final detoxified product harmful. As described herein, a high pH may cause isomerization and/or degradation of the trichothecene molecule. Thus, depending on which substrate is to be detoxified, the thiol to be used has to be selected so that a sufficient reaction rate can be achieved while not rendering the detoxified product useless due to a too high pH being used.

The detoxification reaction proceeds faster at a higher pH as the thiolate was found to be more reactive than the corresponding thiol in the reactions disclosed herein. It is known that exposure of trichothecenes to alkaline conditions leads to isomerization and/or degradation. Since the trichothecene epoxide is known to be unreactive it was expected that isomerization and/or degradation would take place prior to reaction of the epoxide. Unexpectedly, however, alkaline such as mildly alkaline conditions in combination with a thiol were found to detoxify trichothecenes by epoxide ring opening.

As mentioned above, the pH of the reaction mixture is selected to be one pH unit lower than the pKa of a thiol group of the thiol containing compound used or higher. Thus, the pH of the reaction mixture has to be higher for a thiol that has a higher pKa than for a thiol that has a lower pKa. However, even for a thiol containing compound that has a lower pKa, it may be preferred to work at alkaline conditions in order to increase the reaction rate. Thus, the pH of the reaction mixture may be selected to be equal to or higher than one pH unit less than the pKa of a thiol group of the thiol containing compound, provided that the pH of the reaction mixture is selected to be alkaline, i.e. having a pH higher than 7, in particular about 8 or above, such as from about 8 to about 11.5, from about 8 to about 10, from about 9 to about 11.5, from about 9 to about 11 or from about 10 to about 11. Or in other words, the pH of the reaction mixture may be selected to be alkaline but to further fulfil the requirement of having a pH that is equal to or higher than one pH unit less than a thiol group of the thiol containing compound used in the reaction.

The pH of a reaction mixture can be measured using any method known in the art depending on the type of sample that is to be detoxified. For example, pH in food or feed samples may be measured as disclosed in http://www.fao.org/docrep/v5380e/v5380e0a.htm.

The method of the present document may be performed at a pH of about 6 or above, such as 8 or above, such as at a pH range from about 8 to about 11.5 or from about 10 to about 11. Further, the reaction mixture may a pH of about 6 or above, such as 8 or above, such as a pH range from about 8 to about 11.5 or from about 10 to about 11. The aqueous solution may have a pH of about 6 or above, such as 8 or above, such as a pH range from about 8 to about 11.5 or from about 10 to about 11.

The detoxification reaction is allowed to proceed for a time period sufficient to reduce the amount of toxic type A and/or type B trichothecenes in a sample to an acceptable level, such as a level acceptable for consumption by humans or animals. Typically the reaction is allowed to proceed for at least a couple of hours. However, as the thiol containing compound does not necessarily have to be removed from the (previously) contaminated sample there is no upper time limit for how long the reaction may be allowed to proceed. For instance, the reaction may be allowed to proceed from a couple of hours to several days. The reaction may e.g. be allowed to proceed for about 1 hour to one month, from about 4 days to about 7 days, from about 4 days to about one month, or from one day to one month. Exemplary time periods for the reaction are from about one hour to 30 days, from about 6 hours to about 30 days, from about 6 hours to about 14 days, about 6 hours to 14 days, about 6 hours to about 7 days, from about one day to about 7 days, from about 2 days to about 7 days, from about 3 days to about 7 days, from about 4 days to about 7 days, from about 2 to about 5 days or from about 4 to about 6 days, such as for about 1, 2, 3, 4, 5, 6, or 7 days. The reaction may also be performed for about 3 days (i.e. about 36 hours) or more, such as about 3-30 days, 3-14 days, 4-30 days or 4-14 days. The reaction may also be performed for about 7 days or more, such as about 7-30 days or 7-14 days. The reaction may also be allowed to proceed for more than 30 days. The detoxification reaction may also be allowed to proceed during normal processing of a product, such as a grain product, such as during pelleting of feed or during storage of a grain, grain-derived, grain-containing or the like product.

The detoxification reaction may be allowed to take place at ambient temperature, such as room temperature, such as from about 15° C. to about 30° C., from about 18° C. to about 25° C. or from about 20° C. to about 25° C. However, the reaction may also be performed at higher temperatures, such as those commonly employed in food and/or feed production. In this case, temperatures from about 5° C. to 85° C., from about 30° C. to about 85° C., such as from about 30° C. to about 50° C. or from about 30° C. to about 40° C. may be used. It is a significant benefit that the detoxification reaction may be run at room temperature or other moderate temperatures thereby making large scale handling easier. In this context of detoxification of trichothecenes such as type A and/type B trichothecenes, the ability of large scale handling is important due to the often large quantities of contaminated sample needed to be treated. A negative impact on the sample to be detoxified due to the choice of temperature is avoided or minimized by employing temperatures known to be well supported by grains, cereals, agricultural products etc. and therefore commonly used during processing. The reaction may also allowed to proceed at a temperature of about 0° C. to about 85° C.

The method described herein may be performed in the presence of a disulphide formation inhibitor. By adding a disulphide formation inhibitor the thiol group of the thiol containing compound may be prevented from forming a disulphide thereby retaining its nucleophilic properties.

In contrast to the procedure described in U.S. Pat. No. 8,101,803 B2 the method described herein is performed without the addition or presence of an alkane carboxylic acid.

The method described herein may further comprise a step of monitoring the reaction. Analytical methods as known in the art, such as gas chromatography (GC), mass spectroscopy (MS), LC-MS, UV, ELISA immunoassay methods etc. may be used for monitoring purposes.

The method described herein may further comprise a step of isolating the detoxified trichothecene sample. The isolated detoxified trichothecene sample may be subjected to purification using common purification techniques as known in the art. The isolated detoxified trichothecene sample may be stored. During storage, further reaction between any remaining thiol containing compound and non-reacted trichothecene sample may take place. Storage may be performed at temperatures as described herein.

The thiol containing compound used in accordance with the present document may be any thiol containing compound, i.e. a compound containing a thiol group (—SH group). However, preferably, the thiol containing compound is a thiol containing compound which is not toxic in the amounts used in accordance with the present document. Examples of thiol containing compound suitable for use in accordance with the present document are mercaptoethanol, cysteine, aminoethanethiol, thioethanesulfonate and glutathione. In particular, cysteine may be used. It may also be possible to use H₂S. As an example, the thiol containing compound may be selected from the group consisting of hydrogen sulphide (i.e. H₂S), cysteine, glutathione and any combination thereof. In a further example, the thiol containing compound may be selected from the group consisting of methane thiol, hydrogen sulphide, mercaptoethanol, cysteine, aminoethanethiol, thioethanesulfonate, glutathione and any combination thereof. In a further example, the thiol containing compound may be selected so that it has a thiol group with a pKa within the range of from 6.5 to 10, such as from 7 to 10 or such as from 8 to 10. The thiol containing compound may be a single type of thiol containing compound or a mixture of two or more different thiol containing compounds. The thiol containing compound may contain one thiol group. Alternatively, the thiol containing compound may contain two or more thiol groups. The amount of a thiol containing compound to be used will of course depend on the sample type and reaction conditions used. For instance the amount employed may be in the range of from about 0.01 to about 10 mmol/g sample. As an example only, an amount of 0.1-1 mmol/g (e.g. 12-120 mg L-cysteine/g) of the thiol containing compound may be added to a sample. The amounts trichothecene and thiol containing compound may be equivalent. Alternatively, the thiol containing compound may be used in an excess. For instance, 2, 3, 4, 5, 10, 20 or more equivalents of the thiol containing compound may be used. Use of an excess of the thiol containing compound may be desirable when the method is performed under alkaline conditions, since alkaline conditions may degrade the trichothecene.

The detoxification reaction disclosed herein may be used for detoxification of any kind of type A and/or type B trichothecene contaminated sample. The sample may contain one kind of a type A or type B trichothecene toxin, or two or more kinds of type A and/or type B toxins. The sample may also or alternatively contain type C and/or type D trichothecene toxin(s). Typically the sample is a product intended for use as a food or feed, as such or after processing, such as an agricultural product. In a further example, the sample is a food product or a feed product. Exemplary samples to be treated include, but are not limited to, hay or straw, grains or seeds, flour and other milled products, and/or livestock or fish feed. The sample may be a grain-derived or grain-containing product, such as grain or seeds intended for food or feed production. Typical grains include, but are not limited to, oats, barley, maize, rye, rice, sorghum, wheat, teff, triticale, wild rice, finger millet, fonio, foxtail millet, Kodo millet, Japanese millet, Job's Tears, pearl millet, and proso millet. Other examples of sample which may be contamined with trichothecenes include flax, peas, soy, rapeseed and other oilseeds such as sunflower, hemp and poppy. Trichothecene toxins may also occur in other types of food, e.g. in beets. Grain-derived products include, but are not limited to, raw grain, flour and cereals. Also, grass and animal feed products are suitable for detoxification in accordance with the present document.

In order to perform the detoxification, the type A, type B, type C and/or type D trichothecene contaminated sample may be mixed with a thiol containing compound and the pH, if necessary, is adjusted to an acid, neutral or alkaline pH as disclosed herein to ensure that the pH is one pH unit less than the pKa of a thiol group of the thiol containing compound used or higher. The thiol containing compound may be provided in an aqueous solution (i.e. a formulation), such as a buffer, which has the desired pH. As an further example, a formulation of a base and a thiol-containing compound may be added to a trichothecene contaminated sample such as a type A and/or type B trichothecene contaminated sample, such as a cereal grain, prior to food or feed processing, which leads to thiol conjugation of the trichothecene(s) during processing. For example, the thiol containing compound and the base, which may be in a single formulation, may be added prior to pelleting of feed. Livestock feed or fish feed is often produced as pellets, where any of the previously mentioned samples, such as cereals, seeds, hay etc., contaminated with Fusarium toxins, can be present. Even if the sample has been treated, the detoxification process can continue during and after pelleting, or the detoxification can take place during a stage in the pelleting process where pH is high. In a further example, the thiol containing compound and the base, which may be in a single formulation, are added to feed prior to storage. Any type A, B, C and/or D type B trichothecene will then react with the thiol containing compound over time and the feed is thereby detoxified. Treatment of grains, cereals, agricultural products and the like as disclosed herein provides a convenient way of converting type A, type B, type C and/or type D trichothecene contaminated samples usable as food or feed products.

In the method described herein, the mixing of the trichothecene contaminated sample, the thiol containing compound and the aqueous solution in step a) may take place in any order. As an example, step a) may take place by mixing the aqueous solution and the thiol containing compound thereby forming a mixture, and then the mixture is applied or mixed with the trichothecene contaminated sample. In a further example, step a) may take place by addition of the thiol containing compound to a mixture of the trichothecene contaminated sample and the aqueous solution. In still a further example, step a) may take place by addition of the aqueous solution to a mixture of the thiol containing compound and the trichothecene contaminated sample.

The thiol containing compound in step a) of the method described herein may be contained within the trichothecene contaminated sample. Step a) of the method described herein may then take place by mixing the aqueous solution and the trichothecene contaminated sample containing the thiol containing compound. Additionally, a further thiol containing compound may be added. The further thiol containing compound may be the same and/or different from the thiol containing compound contained within the trichothecene containing sample.

The present document is also directed to a product obtainable or obtained by the method for detoxification disclosed herein.

The present document is also directed to the use of a thiol containing compound for detoxification of a trichothecene contaminated sample by epoxide ring opening of said trichothecene. The trichothecene contaminated sample may be a type A trichothecene contaminated sample, a type B trichothecene contaminated sample, a type C trichothecene contaminated sample and/or a type D trichothecene contaminated sample.

### Further Aspects

The present disclosure further relates to the following further aspects.
Further aspect 1. A method for detoxification of a type A and/or type B trichothecene contaminated sample, said method comprising the step of reacting said type A and/or type B trichothecene contaminated sample with a thiol containing compound under alkaline conditions.
Further aspect 2. The method according to further aspect 1, wherein said type A and/or type B trichothecene is deoxynivalenol, nivalenol, T-2 toxin and/or HT-2 toxin.
Further aspect 3. The method according to further aspect 1 or 2, wherein said method comprises epoxide ring opening of said type A and/or type B trichothecene.
Further aspect 4. The method according to any one of the preceding further aspects, wherein said method further comprises Michael addition to the 9,10 double bond of said type A and/or type B trichothecene.
Further aspect 5. The method according to any one of the preceding further aspects, wherein said alkaline conditions are provided by a strong or a weak base.
Further aspect 6. The method according to further aspect 5, wherein said weak base is a base having a pKₐ of from about 7 to about 11, such as from about 9 to about 11.
Further aspect 7. The method according to further aspect 5 or 6, wherein said weak base is selected from the group consisting of carbonates, borates and amines.
Further aspect 8. The method according to further aspect 5, wherein said strong base is selected from the group consisting of sodium hydroxide or potassium hydroxide.
Further aspect 9. The method according to any one of the previous further aspects, wherein said step of reacting is allowed to proceed for from about 4 to about 7 days.
Further aspect 10. The method according to any one of the previous further aspects, wherein said step of reacting takes place at room temperature.
Further aspect 11. The method according to any one of further aspects 1-9, wherein said step of reacting takes place at elevated temperatures commonly employed in food and feed production of from about 30° C. to about 85° C.
Further aspect 12. The method according to any one of the preceding further aspects, wherein said method is performed at a pH of about 8 or above, such as a pH range from about 8 to about 11.5 or from about 10 to about 11.
Further aspect 13. The method according any one of the preceding further aspects, wherein said thiol containing compound is one or more from the group consisting of mercaptoethanol, cysteine, aminoethanethiol, thioethanesulfonate and glutathione.
Further aspect 14. The method according to any one of the preceding further aspects, wherein said sample is hay or straw, grains or seeds, flour and other milled products, and/or livestock or fish feed.
Further aspect 15. The method according to any one of the preceding further aspects, wherein said sample is a grain-derived or grain-containing product, such as grain intended for food or feed production.
Further aspect 16. Use of a thiol containing compound, for detoxification of a type A and/or type B trichothecene contaminated sample by epoxide ring opening of said type A and/or type B trichothecene.
Further aspect 17. A kit of parts comprising a thiol containing formulation and a strong or a weak base in the same container, and instructions for use involving detoxification.
Further aspect 18. A kit of parts comprising a thiol containing formulation and a strong or a weak base in separate containers, and optionally instructions for use involving detoxification.

The invention will be further described in the following examples, which do not limit the scope of the invention described in the claims.

### EXPERIMENTAL SECTION

### Reagents

Pure deoxynivalenol (DON) was purchased either from either Sigma-Aldrich (St. Louis, Mo., USA) or Biopure (Romer Labs, Tulln, Austria). The following reagents were purchased from Sigma-Aldrich: sodium carbonate, mercaptoethanol, aminoethanethiol, thioethanesulfonate and L-cysteine. Sodium bicarbonate was from Merck (Darmstadt, Germany), ammonium carbonate from Fluke (Buchs, Switzerland) and phosphate buffered saline from Oxoid (Hampshire, UK). Solvents used for chromatography were of LC-MS quality (Fisher Scientific, Leics, UK).

General Procedure for Reaction of DON with Thiols

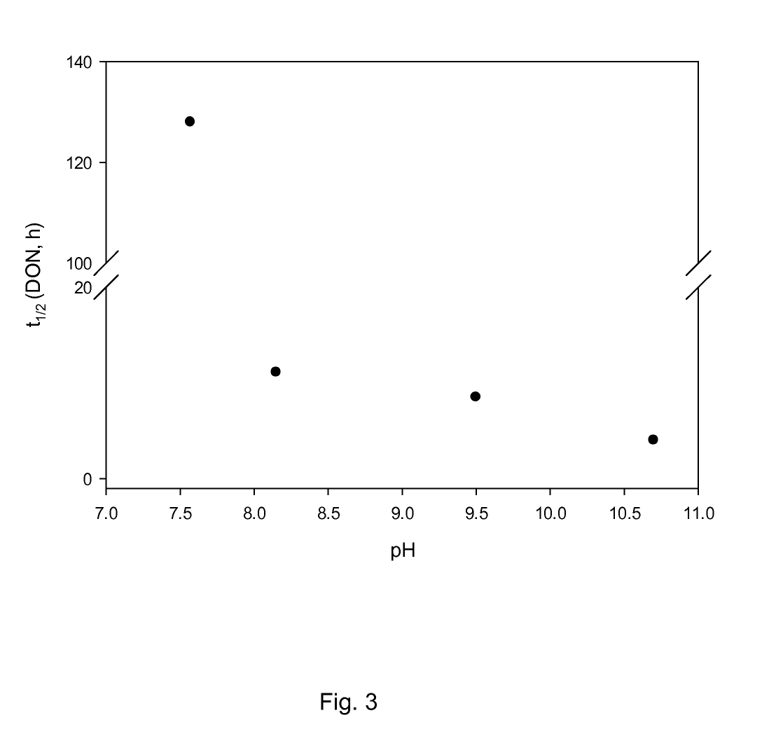

DON (1.5 mg, 5.06 μmol) was dissolved in 1 mL of either 0.2 M carbonate buffer (pH 9.6 or 10.7), 0.2 M ammonium carbonate (pH 8.15) or 0.172 M phosphate buffered saline (pH 7.5) in a 1.5 mL chromatography vial, and 7.10 μmol (0.5 μL) of mercaptoethanol added to the solution (FIGS. 2 and 3). The vial was flushed with argon in order to reduce oxidation of the thiol and sealed. The vial was placed in an autosampler, which was temperature controlled and set to 25° C. The reaction was monitored by HPLC/ion trap mass spectrometry or HPLC/high-resolution mass spectrometry for up to seven days (FIGS. 2 and 4). For the reaction of DON with other thiols, the thiol was directly dissolved in carbonate buffer (pH 10.7) and the solution added to a dried aliquot of DON.

### High-Performance Liquid Chromatography/Mass Spectrometry (HPLC/MS)

The reaction of DON with each of the thiols was monitored using the following HPLC/MS instruments: a Finnigan Surveyor HPLC system interfaced to a LTQ linear ion trap mass spectrometer (Thermo Fisher, Waltham, Mass., USA) and a Waters Acquity UPLC (Milford, Mass., USA) interfaced to a Q-Exactive high-resolution mass spectrometer (Thermo Fisher, Bremen, Germany). HPLC was performed using a 150×2.1 mm Atlantis T3 column (Waters, 3 μm particles) (FIG. 2). Elution was at 0.3 mL/min. Mobile phase A water containing 2.5 mM of ammonium formate and formic acid, mobile phase B was prepared by dissolving 2.5 mM of ammonium formate and formic acid in 25 mL of water and adding acetonitrile to a final volume of 1 L. Separation was performed by eluting the column with the gradient from 5% to 15% A over 15 min, then to 100% at 20 min with a 3 minute hold followed by a return to 5% with a 3 min hold for the equilibration of the column. The ion trap MS was run in the full-scan mode in the mass range m/z 180-600. The electrospray interface (ESI) was operated in the negative mode, and ESI parameters as well as capillary voltage and tube lens offset were tuned by continuous infusion of a 5 μg/mL solution of DON in acetonitrile into a mobile phase composed of 9:1 NB.

### Purification of Reaction Products

Reaction mixtures were desalted using 500-mg Strata-X polymeric reversed phase columns (Phenomenex, Torrance, Calif.) that had been activated and conditioned with 5 mL of methanol and 5 mL of water. After application of the entire reaction mixture, the columns were washed with 5 mL of water, dried under vacuum and then eluted with 5 mL of methanol. The eluent was concentrated to 1 mL and individual reaction products separated by semipreparative HPLC using an Atlantis T3 column (250×10 mm, 5 μm particles; Waters) with a Shimadzu LC20AD pump (Shimadzu Corporation, Kyoto, Japa). The flow rate was 3 mL/min, and the column was eluted with a gradient of water (A) and acetonitrile (B). Starting conditions were set to 5% B and increased to 21% B over 17 min. The column was flushed with 100% B for 3 min, and then returned to 5% B and equilibrated for 5 min. A portion of the eluent (0.1%) was continuously split into a LCQ Fleet ion trap MS (Thermo Fisher) to monitor the separation.

### Nuclear Magnetic Resonance Spectroscopy (NMR)

NMR spectra of mercaptoethanol conjugates of DON were obtained from solutions (500 μL) in acetonitrile-d3 (CD₃CN; Sigma-Aldrich). The spectra were acquired on an Avance AVI or AVII 600 MHz NMR spectrometer (Bruker BioSpin, Fällanden, Switzerland) equipped with a 5 mm CP-TCI (1H/13C, 15N-2H) triple-resonance inverse cryoprobe with a Z-gradient coil. NMR assignments were obtained from the examination of 1H, JMOD, COSY, TOCSY, g-HSQC, g-HMBC, NOESY and ROESY NMR spectra.

### Reduction of DON in Cereal Grain Extract

Aliquots (1 g) of ground wheat was weighed into 15-mL Greiner tubes (Greiner Bio-One, Kremsmünster, Austria) and spiked with 1 μg/g DON. In addition, aliquots (1 g) of a commercial, naturally contaminated, wheat check sample containing 1.4 μg/g DON (Romer Labs) were weighed into 15-mL Greiner tubes. To the samples 5 mL of a 0.2 M carbonate buffer (pH 10.7), containing 10.5 mM of L-cysteine was added and the tubes shaken on a rotary shaker. Subsamples were centrifuged and filtered through 0.22 μm Nylon filters (Costar Spin-X, Corning, Inc., Corning, N.Y., USA) after 2 and 24 hours, and analysed using HPLC/high-resolution MS.

### Further Examples

### Materials and Methods

Chemicals and Reagents.

HPLC grade water and acetonitrile were obtained from Thermo Fisher Scientific (Waltham, Mass.). Ammonium formate (puriss. p.a. for HPLC) from Fluke (Sigma-Aldrich, St. Louis, Mo.). Solid deoxynivalenol (DON) was purchased from Sigma-Aldrich ((≧98%), St. Louis, Mo.), as well as the following thiols: 2-mercaptoethanol (≧99.0%), 2-aminoethanethiol (≧98%), sodium methanethiolate (technical grade (>90%)) and sodium 2-mercaptoethanesulfonate (≧98%), L-cysteine (≧98%) and reduced L-glutathione (≧98%). Phosphate-buffered saline (pH 7.3, 0.172 M) was prepared from ready-to-use tablets (Oxoid, Hampshire, UK). Sodium bicarbonate (pro analysis, Merck, Darmstadt, Germany) and sodium carbonate (pro analysis, Sigma-Aldrich, Steinheim, Germany) were used for the preparation of 0.2 M buffer solutions at pH 9.2 and 10.7. Buffer pH was measured at ambient temperature with a Mettler Delta 320 pH meter. Solutions of T-2 tetraol (50.3 μg/mL) and deepoxy-DON 50.5 μg/mL) in acetonitrile were from Biopure (Romer Labs, Tulln, Austria). Standards of norDON B and norDON C were provided by Institute of Food Chemistry, Münster, Germany. Alamar Blue and human TNF-α Cytoset were from Invitrogen (Life Technologies, Carlsbad, Calif.) and human IL-1β/IL-1F2 Duoset from R&D Systems (Minneapolis, Minn.). RPMI 1640, Penicillin/Streptomycin, Fetal bovine serum (FBS) and PBS were from Lonza (Verviers, Belgium). Phorbol-12-myristate-13-acetate (PMA) was from Calbiochem (La Jolla, Calif.). E. coli Lipopolysaccharide (LPS) was from Sigma-Aldrich (St. Louis, Mo.).

Reaction of Trichothecenes with Thiols.

All reactions were conducted in 2 mL HPLC vials and monitored by LC-MS or LC-HRMS.

Procedure 1 (analytical scale). Aliquots (0.33 μmol) of the stock solutions of DON, deepoxy-DON and T-2 tetraol in acetonitrile were evaporated under a stream of N₂ at 60° C.), dissolved in carbonate buffer (pH 10.7; 1.0 mL), and mercaptoethanol 0.5 μL (7.13 μmol) was added. The vials were flushed with argon, sealed, and placed in the auto sampler set to 25° C. Reactions were followed by LC-MS (Method A1) for one month. The reaction of DON with mercaptoethanol was also carried out in carbonate buffer at pH 9.2 and in phosphate-buffered saline at pH 7.3.

Procedure 2a (preparative scale). Mercaptoethanol (10 μL, 142 μmol) was added to a solution of DON (1.0 mg, 3.3 μmol) in carbonate buffer (1 mL; pH 10.7), and the reaction followed by LC-MS for ca 3 weeks (Method A1), by which time DON was absent and the peak intensity of 1a/1b was equal to that of 2b.

Procedure 2b (preparative scale). Mercaptoethanol (15 μL, 210 μmol) was added to a solution of DON (1.5 mg, 5.1 μmol) in carbonate buffer (1.5 mL; pH 10.7), and the reaction followed by LC-MS for 14 days, by which time the peak intensities of 2a and 2b were about equal and dominated the chromatogram.

Procedure 3 (analytical scale). Solutions (1 mL) of other thiols (71.3 mM) (i.e. other than mercaptoethanol) in carbonate buffer (pH 10.7) were added to solid DON (100 μg, 0.33 μmol) and reactions were monitored by one or more LC-MS (Methods A1, A2, B1 or B2) for three weeks.

LC-MS.

HPLC was performed using an Atlantis T3 column (150×2.1 mm, 3 μm; Waters). The flow rate was 0.3 mL/min, and the injection volume was 1.5 μL. Mobile phase A was 5 mM ammonium formate in MeCN-water (19:1) and mobile phase B was aqueous ammonium formate (5 mM). Gradient 1. Separation was performed by eluting with a linear gradient of 5% to 15% A over 15 min, then to 100% A at 20 min, with a 3 min hold followed by a return to 5% A with a 3 min hold to equilibrate the column. Gradient 2. This was identical to Gradient 1, except that the gradient started and ended with 0.5% A (instead of 5% A).

Method A1.

A Finnigan Surveyor HPLC system was used with Gradient 1 and interfaced to an LTQ linear ion trap mass spectrometer (Thermo Fisher Scientific) operated in negative ionization full scan mode (m/z 180-600) and fitted with an electrospray ionization (ESI) interface. This method was used to monitor the reactions of DON, T-2 tetraol and deepoxy-DON with mercaptoethanol, as well as reactions of DON with sodium methanethiolate and sodium 2-mercaptoethanesulfonate. Capillary voltage and tube lens offset were tuned with continuous infusion of DON (10 μg/mL) in acetonitrile into a mobile phase composed of 10% A. The spray voltage was set to 3 kV, the sheath gas and auxiliary gas flow rates were 58 units and 11 units, respectively, and the capillary temperature was 250° C.

The MSⁿ (where n=2-5) fragmentation of DON was studied using collision-induced dissociation in the ion trap by directly infusing 10 μg/mL DON in acetonitrile into a mobile phase composed of 10% A, via the instrument syringe pump (5 μL/min). In this context, n stands for the number of fragmentation steps. The ESI settings were as described above. Individual precursor ions were selected with an isolation width of 2 m/z, the activation Q was set to 0.25, and the activation time was set to 30 ms. The collision energy was chosen such that the intensity of the precursor ion was less than 10% relative peak intensity. Product spectra were recorded for 30 seconds.

Method A2.

As for Method A1, except that Gradient 2 was used for elution and the MS was run in positive mode for m/z 100-1000, in order to monitor the reaction of DON with 2-aminoethanethiol, glutathione or cysteine.

Method B1.

A Waters Acquity UPLC (Milford, Mass., USA) used with Gradient 1 was interfaced to a Q Exactive Fourier-transform high resolution mass spectrometer (Thermo Fisher Scientific) and used for analysis of the products from the reactions of DON, T-2 tetraol and deepoxy-DON with mercaptoethanol, and of DON with sodium methanethiolate and sodium 2-mercaptoethanesulfonate. A heated electrospray interface was used for ionization with a spray voltage of 3.8 kV and a temperature of 300° C. The mass spectrometer was run in the negative full-scan mode in the mass range m/z 150-600. The mass resolution was set to 70,000 at m/z 200. Other important interface parameters included a capillary temperature of 250° C., a sheath gas flow rate of 55 units and an auxiliary gas flow rate of 25 units.

For targeted MS/MS, [M+HCOO]⁻ of mercaptoethanol derivatives were selected and subjected to higher-energy collisional dissociation (HCD) at a normalized collision energy of 35 eV. The resolution was set to 17,500 at m/z 200 and the product ions were scanned in the mass range m/z 50-365, m/z 50-445 or m/z 50-525 (as appropriate).

Method B2.

As described for Method B1, except that Gradient 2 was used for elution and the MS was run in positive mode for m/z 100-1000, in order to monitor the reaction of DON with 2-aminoethanethiol, glutathione or cysteine.

Method C.

Preparative LC-MS was performed by injecting portions (150 μL) onto an Atlantis T3 column (250×10 mm, 5 μm; Waters). The column was eluted with a Shimadzu LC-20AD pump (Shimadzu Corporation, Kyoto, Japan) at 3 mL/min. A portion of the column effluent (0.1%) was continuously split into an LCQ Fleet ion trap mass spectrometer (Thermo Fisher), while individual fractions containing target compounds were collected manually.

Purification of DON-Mercaptoethanol Derivatives.

Reaction mixtures from Procedures 2A and 2B were fractionated on Strata-X SPE columns (500 mg; Phenomenex, Torrance, Calif.). The SPE column was conditioned with methanol (10 mL) then water (10 mL), and the reaction mixture was applied. The columns were eluted with 5 mL each of 0%, 5%, 10%, 15%, 20%, 25%, 40%, 50% MeOH in water, and then finally with MeOH. The 40% and 50% MeOH fractions from Procedure 2A contained 1a/1b and 2a/2b, and were combined and evaporated to ca 1 mL under a stream of N₂. The components were purified by preparative LC-MS (Method C) using a linear gradient of water (A) and acetonitrile (B) (from 5% to 21% B over 17 min, then 100% B for 3 min, and finally to 5% B for 5 min to equilibrate the column), with 1a/1b eluting at 14.5 min and 2a/2b (ca 1:5 by NMR) at 16.8 min.

When the mixture obtained from Procedure 2B was chromatographed with the stepwise gradient the 40% MeOH fraction contained 2a/2b. This material was concentrated to 1 mL as above and purified by preparative LC-MS (Method C) using isocratic elution with 21% MeCN in water, with 2a/2b (ca 1:1 by NMR) eluting at 6.6 min.

NMR Spectroscopy.

1-D (¹H, SELTOCSY, SELROESY, ¹³C, JMOD, DEPT135) and 2-D (COSY, TOCSY, HSQC, HMBC, NOESY, ROESY) NMR experiments were conducted with Bruker Avance AV 600 MHz and AVII 600 MHz NMR spectrometers equipped with 5 mm CP-TCI (¹H/¹³C, ¹⁵N-²H) triple-resonance inverse cryoprobes with Z-gradient coils. Compounds were dissolved in CD₃CN (99.95 atom-% D; Sigma-Aldrich, St. Louis, Mo.) in 5.0 mm Wilmad NMR tubes (Sigma-Aldrich). Data were recorded and processed using Bruker TOPSPIN (version 2.1 and 3.0) software and chemical shifts, determined at 25° C., are reported relative to internal CHD₂CN (1.96 ppm) and CD₃CN (118.26 ppm). (J. Org. Chem. 1997, 62, 7512-7515).

Cell Culture and Treatments.

The human acute monocyte leukemia cell line (THP-1) was obtained from European collection of cell cultures (ECACC), and grown in RPMI 1640 supplemented with 10% heat-inactivated FBS (EU standard), penicillin (100 U/mL), and streptomycin (100 μg/mL) (all from Lonza, Verviers, Belgium). The cells were cultured at 37° C. under 5% CO₂ in a humidified incubator and kept in a logarithmic growth phase at 5-15×10⁵ cells/mL through routine sub-culturing, according to standard ECACC protocol. The passage number was kept below 20. DON and its derivatives were dissolved in PBS and applied to the cells at a final concentration of 4 μM.

Proliferation.

THP-1 cells (monocytes) were seeded at 150,000 cells/cm² and, following exposure with DON and the conjugates, the metabolic activity of the THP-1 cells was measured using the Alamar Blue assay according to the manufacturer's protocol. The dark blue oxidized form of Alamar Blue is reduced to a highly fluorescent form in functional mitochondria, (Brain Research Protocols 1998, 2, 259-263) and the measured fluorescence intensity is thus proportional to the number of viable cells. The fluorescence (585 nm) was quantified using a Victor2 Multilabel Counter (PerkinElmer, Boston, Mass., USA).

Cytokine Measurement, ELISA.

Secreted cytokines were measured with an enzyme linked immunosorbent assay (ELISA). THP-1 cells were seeded at 260,000/cm² and differentiated into macrophages by treatment with PMA (50 ng/mL) for 24 h. The medium was then replaced and the cells rested for 24 h before exposure. The cells were then treated with lipopolysaccharide (LPS, 0.05 ng/mL) for 3 h followed by toxin exposure for an additional 24 h. The medium was harvested and centrifuged (500×g, 4° C., 10 min) to remove cell debris. Levels of TNF-α and IL-1β in supernatants were measured by ELISA, using human TNF-α Cytoset (Invitrogen) or human IL-1β/IL-1F2 Duoset (R&D systems), respectively, according to the manufacturers' guidelines. The absorbances were measured using a plate reader (TECAN Sunrise, Phoenix Research Products, Hayward, Calif., USA) equipped with analysing software (Magellan VI).

Statistical Analysis.

Data analyses were performed using Sigma Plot version 13.0. Statistical significance (p<0.05) was assessed using 1-way-ANOVA, followed by Dunnett's post-test.

### Results

Reaction of DON, Deepoxy-DON and T-2 Tetraol with Mercaptoethanol.

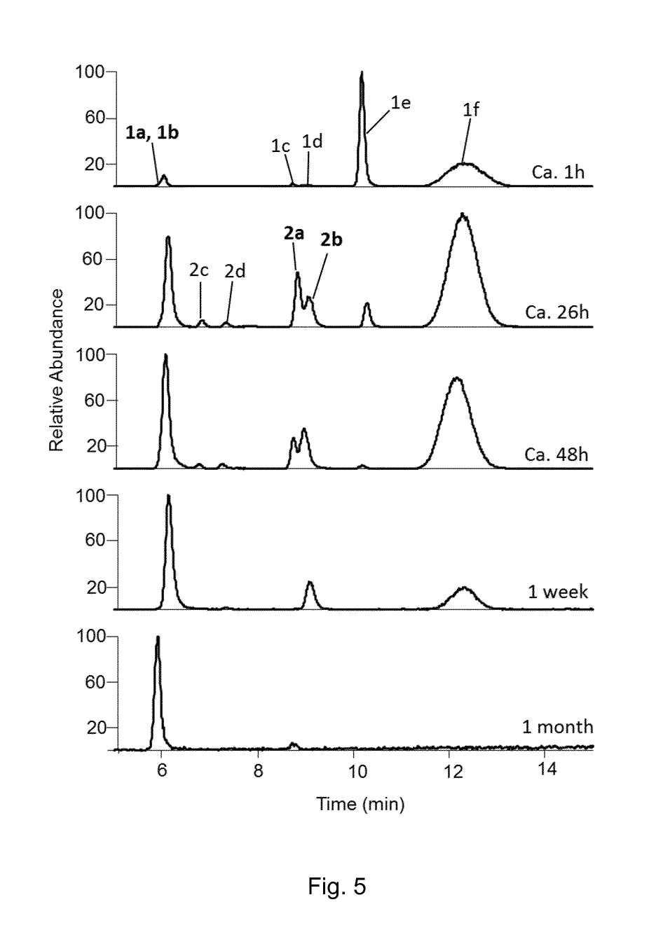

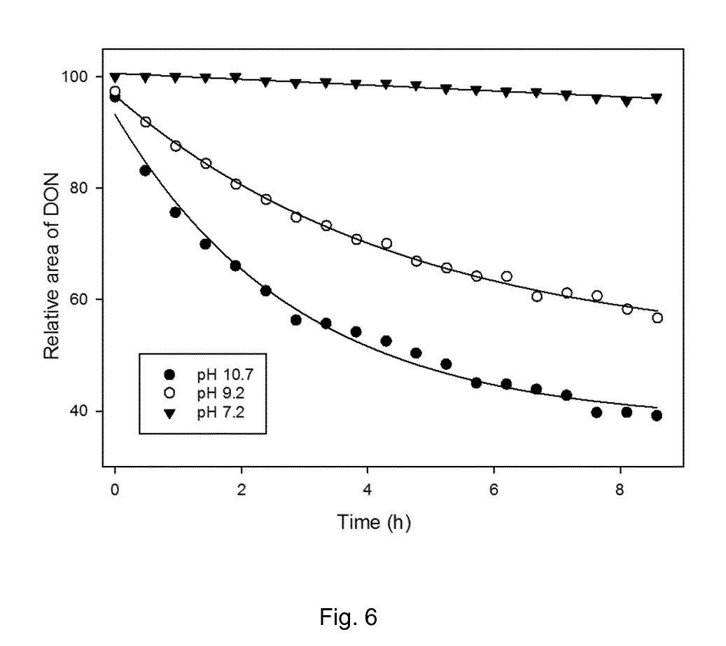

Initial experiments followed the reaction of DON using LC-MS (Method A1) for up to 1 month, with mercaptoethanol as a model thiol under neutral and weakly basic conditions (Procedure 1). Mercaptoethanol was used because it was expected to produce DON derivatives with retention times and ionization properties similar to those DON itself, thereby facilitating monitoring of the reaction and its products by LC-MS. At pH 10.7 there was rapid formation of 1e and 1f (FIG. 5) with a mass difference of 78 Da relative to formate adduct of DON, corresponding to a single addition of mercaptoethanol. After half an hour, peaks corresponding to 1a/1b (not resolved), 1c and 1d were also detected with the same m/z (FIG. 5), along with 2a and 2b (FIG. 5) mass difference of 156 Da relative to DON corresponding to addition of two molecules of mercaptoethanol. The ratios of these peaks then changed over time, with 1a/1b becoming more prevalent until they were the only compounds remaining in the mixture. Initially, altogether four peaks corresponding to addition of two molecules of mercaptoethanol were detected, but 2c and 2d were minor and had disappeared after 1 week. Products 2a and 2b were the prominent double-addition conjugates, but 2a disappeared gradually in less than a week leaving 2b as the most prominent double-addition conjugate. However, 2b also slowly disappeared with time, so that after 1 month the major peak was from 1a/1b. Although DON is not included in the chromatograms in FIG. 5, the relative concentration was gradually reduced as the reaction progressed (FIG. 6) and was no longer detectable after three weeks.

We anticipated that thiol addition was most likely to occur reversibly at the C-10 carbon of the α,β-unsaturated ketone in DON and irreversibly at the epoxy group in DON. In order to test this hypothesis, we exchanged DON with either T-2 tetraol or deepoxy-DON in our reactions. In T-2 tetraol the C-8 carbon is hydroxylated resulting in a 9,10-double bond that is not conjugated, while in deepoxy-DON the epoxide ring has been reduced. (FIG. 1). The reaction of T-2 tetraol was followed for one week by LC-MS (Method A1), during which time just one new, later-eluting peak appeared, corresponding to addition of one mercaptoethanol molecule. LC-HRMS analysis (Method B1) of this peak revealed it had m/z 421.1541, corresponding to C₁₈H₂₉O₉S⁻ ([T-2 tetraol+HSEtOH+HCOO]⁻, Δ 0.9 ppm) Similarly, the reaction mixture containing deepoxy-DON gave in total four peaks with m/z 403.1437-403.1443 corresponding to O₁₈H₂₇O₈S⁻ ([deepoxy-DON+HSEtOH+HCOO]⁻, Δ 1.2-2.9. ppm), of which only two were more abundant then deepoxy-DON itself In both cases, no double adducts were detected.

These results indicated that 1c, 1d, 1e and 1f were products from Michael addition of mercaptoethanol to the 9,10-double bond of DON, while the relatively early eluting 1a/1b was attributable to addition of mercaptoethanol to the epoxy group in DON.

During the reaction of DON with mercaptoethanol under basic conditions, several minor products with masses similar to that of DON were detected by LC-HRMS. They appear to be identical to those reported earlier (J. Agric. Food. Chem. 2006, 54, 6445-6451, Bretz et al.) due to DON degradation under basic conditions, and the presence of norDON B and norDON C, in the DON-mercaptoethanol reaction mixtures was confirmed using authentic standards. Because these DON degradation reactions compete with the thiol addition, higher concentrations of thiols (approximately 20-fold) were used in the preparative reactions (Procedures 2a and 2b) to reduce the reaction time and thereby minimize the effect of the degradation reactions.

In order to lower the possibility of oxidation in our reaction mixtures, we flushed vials with argon.

Preparative Synthesis and Purification.

DON and mercaptoethanol were reacted on a preparative scale (Procedures 2a and 2b) to identify the major products. Two reactions were followed by LC-MS: one was stopped when almost equal ratios of 1a/1b and 2b were present (Procedure 2a) and the other when the ratios of 2a and 2b were equal (Procedure 2b). Fractionation of the reaction mixtures by SPE followed by preparative LC-MS afforded pure mixtures of 1a together with 1b, and of 2a together with 2b.

Structural Elucidation.

Structural elucidation of major products was done on mixtures of 1a and 1b, and of 2a and 2b, in CD₃CN, with DON used for spectral comparison. Although the LC-HRMS showed a single peak for 1a/1b, with m/z 419.13827 consistent with C₁₈H₂₇O₉⁻ (DON+HSEtOH+HCO₂]⁻), indicating the addition of one molecule of mercaptoethanol to DON. However, NMR spectroscopy revealed the presence of two isomeric compounds in a ratio of 5:1. Three of the most diagnostic pairs of signals were methyl singlets at 1.27 and 1.24 ppm (H-14), methyl triplets at 1.74 and 1.81 and (H-16), and olefinic protons (both doublets of quartets) at 5.35 and 6.44 ppm (H-10). The presence of an olefinic proton in 1a and 1b indicates that addition of mercaptoethanol cannot have occurred at C-10. Examination of the COSY and TOCSY spectra of the major isomer (1a) revealed a number of relatively short spin systems corresponding to H-16/H-10/H-11, H-2/H-3/3-OH/H-4a/H-4b/H-14, H-13a/H-13b, H-7/7-OH, H-15a/H-15b, and H-17H-272′-OH. The corresponding protonated carbon resonances were assigned from HSQC correlations, and connections between systems were established via correlations observed in HMBC spectra. Of particular note were HMBC correlations from the methyl triplet at 1.74 ppm (H-16) to 104.7 (C-8), 142.4 (C-9), and 122.9 (0-10) ppm, and from H-15a/H-15b (4.09 and 3.31 ppm) to 104.7 (C-8), 77.7 (C-7), 50.8 (C-5) and 51.8 ppm (C-6), establishing 1a as a hemiketal derivative at C-8 generated by intramolecular addition of the oxygen atom on C-15; and correlations between 2.99/3.55 ppm (H-13a and H-13b) and 37.0 ppm (C-1′), and between 2.71 ppm (H-1′) to 36.3 ppm (0-13), establishing attachment of the mercaptoethanol moiety at C-13 via nucleophilic attack on the epoxy group of DON.

Examination of the corresponding spectra of the minor component (1 b) for the most part revealed very similar spin systems and correlations. Notable exceptions included that in the HMBC spectrum of 1b, the methyl triplet at 1.81 ppm (H-16) showed correlations to 200.7 (C-8), 134.9 (C-9), 139.7 (0-10) ppm; and that the COSY/TOCSY spectra of 1b included a spin system corresponding to H-15a/H-15b/15-OH. The H-15 protons in 1b occurred as doublets of doublets via coupling to the 15-OH, in contrast to 1a, which occurred as a pair of doublets due to the absence of a 15-OH resulting from the hemiketal linkage in 1a. These results reveal the minor component (1b) to be the ketone analogue corresponding to hemiketal-1a

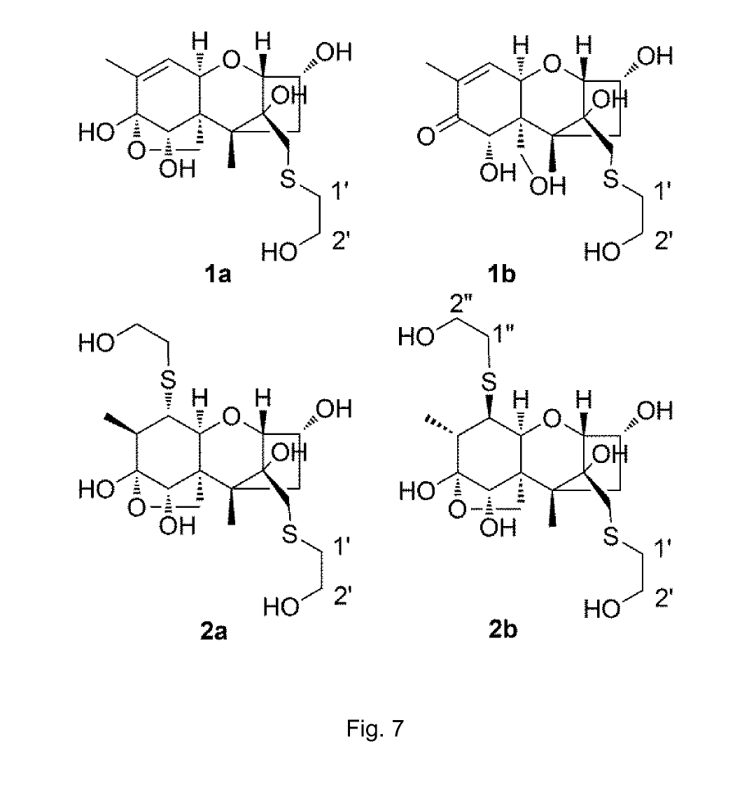

Compounds 2a and 2b were isolated twice as mixtures, once in a ca 1:1 ratio and once in a ca 1:5 ratio, which facilitated identification of NMR signals associated with the two components. LC-HRMS showed 2a and 2b with m/z 497.1524 and 497.1523, corresponding to C₂₀H₃₃O₁₀S₄⁻ (Δ 0.7 and 0.6 ppm, respectively) corresponding to addition of two mercaptothanol molecules to DON (i.e. [DON+(HSEtOH)₂+HCO₂]⁻). COSY, TOCSY and SELTOCSY NMR spectra were used to identify spin systems corresponding to H-16/H-9/H-10/H-11, H-2/H-3/3-0H/H4a/H-4b/H-14, H-15a/H-15b, H-7/7-OH, H-13a/H-13b, H-17H-2′/2′-OH, and H-1a″/H-1b″/H-2″/2″-OH for both 2a and 2b. Protonated carbon resonances were assigned from correlations in HSQC spectra, HMBC correlations were used to assign non-protonated carbon resonances and to connect the spin systems, and NOESY, ROESY and SELROESY correlations established stereochemistry via through-space interactions. In contrast to 1a/1b and DON, NMR spectra of 2a and 2b lacked resonances attributable to olefinic protons or carbons, suggestive of thiol addition to C-10 in 2a and 2b. Consistent with this, the H-16 methyl resonances of 2a and 2b were shifted up-field relative to DON and 1a/1b, and appeared as ca 7 Hz doublets, indicating the presence of a proton on C-9. COSY correlations established for both 2a and 2b, H-9 was coupled to H-10 as well as to the 16-methyl group, establishing that addition of a mercaptoethanol molecule had occurred at C-10 (Michael addition) of DON. This conclusion was supported by HMBC correlations observed between H-10 (2.41/2.77 ppm) to C-16 methyl (17.4/13.3 ppm) and C-1″ (35.6/35.1 ppm). No carbonyl resonances were observed in the ¹³C, JMOD or HMBC experiments, however, for both 2a and 2b there was an HMBC correlation between H-16 (1.80/1.78 ppm) and a hemiketal carbon at C-8 (107.7/106.6 ppm). Location of the second mercaptoethanol molecule was assigned to C-13 position as result of the nucleophilic attack on the epoxy group of DON. HMBC correlations from H-13 (2.94/3.09 ppm) to C-2 (80.9/83.1 ppm), C-12 (81.6/81.3 ppm), C-5 (50.4/51.0 ppm) and C-1′ 36.8/37.1 ppm) are confirming that position. Thus, 2a and 2b have the same skeleton, only differing in their stereochemistries at C-9 and C-10, which is reflected in the differing coupling constants for this spin system (Table 1). The stereochemistries at C-9 and C-10 were established from ROESY (Figure S7) and SELROESY experiments. For 2a, there were ROESY correlation between H-7 and both H-16 (not observed for 2b) and H-10, locating H-10 and the 16-methyl together with H-7 on the β-face of the molecule. In the case of 2b, however, H-7 showed a ROESY correlation to H-9, while H-10 showed ROESY correlations to H-11 and H-15 (3.52/3.49 ppm). This locates H-10 and the 16-methyl group on the α-face, and H-9 on the β-face of the molecule in 2b. This situation places the 16-methyl and mercaptoethanol substituents, attached at C-9 and C-10, respectively, equatorially on the ring in both 2a and 2b, and would be expected to result in the least steric crowding in this region of these molecules. The chemical structures 1a, 1b, 2a and 2b are indicated in FIG. 7.

Reaction of DON with Other Thiols.

A set of experiments using Procedure 3 were carried out to see if DON reacted similarly with mercaptoethanol, 2-aminoethanethiol, cysteine and glutathione. Reactions were monitored for one week by LC-MS and all showed peaks corresponding to addition of a single thiol molecule to DON. The chromatograms displayed similar patterns of broad and sharp, later- and earlier-eluting peaks to those observed with mercaptoethanol. A wider array of thiol-addition isomers formed in a shorter time period for the reactions with mercaptoethanol and 2-aminoethanethiol, presumably as a consequence of reduced steric hindrance. Double-conjugates (i.e. compounds to which two thiol molecules had been added) were also present in all of the reaction mixtures. However, when the mixtures were analyzed after the reaction had been allowed to proceed for approximately 45 days at room temperature, there was only one early-eluting peak present whose mass corresponded to addition of a single thiol believed to be equivalent to the identified 1a/1b epoxide adducts in the DON-mercaptoethanol reaction. Thus, these experiments strongly indicate that the thiol adds to the DON-epoxide leading to DON-epoxide ring opening.

LC-HRMS and LC-MSⁿ.

In this context, n stands for the number of fragmentation steps. We studied the MS characteristics and fragmentation patterns of DON and its mercaptoethanol derivatives using LC-HRMS, LC-HRMS² as well as multiple stage ion trap LC-MSⁿ. Upon electrospray ionization in the negative ion mode, compounds 1a-1f afforded formate adducts with m/z 419.1382-419.1384, corresponding to an elemental composition of C₁₈H₂₇O₉S⁻ (Δ 0.3-0.5. ppm), while compounds 2a-2d afforded formate adducts with m/z 497.1523-497.1524 corresponding to an elemental composition of C₂₀H₃₃O₁₀S₂⁻ (Δ 0.5-0.7 ppm). The formate adducts of 1a/b, 1e/f and 2a/b showed different fragmentation patterns during LC-HRMS² attributable to different fragmentation pathways for the epoxide conjugates and Michael addition products, potentially allowing the two types of addition products to be distinguished by MS alone. In order to understand these differences, the fragmentation spectra of the mercaptoethanol adducts were compared to those of DON The fragmentation pathways of DON were studied in more detail by multiple stage ion trap MSⁿ. Fragmentation of the deprotonated molecular ions of DON (m/z 295), obtained from collision-induced MS² fragmentation of its corresponding formate adduct (m/z 341), primarily yielded m/z 265 (loss of CH₂O). Further fragmentation of m/z 265 (MS⁴) yielded m/z 247 (loss of H₂O), m/z 217 (loss of H₂O and CH₂O) and m/z as the most abundant product ions. The two losses of CH₂O during MS fragmentation of DON are attributable to cleavage of the CH₂OH side-chain at C-6 and cleavage of the epoxide, as proposed previously (J. Mass spectrom. 2012, 309, 133-140, Liu et al). The m/z 138 fragment appears to be a rare radical anion, and has earlier been suggested to be the result of cleavage through the B-ring of the molecule. (J. Mass Spectrom. 2012, 309, 133-140). An m/z 138.0311 product ion was present in the LC-HRMS² spectra of the DON, 1e and 1f, but not in compounds where mercaptoethanol was known to be added to the epoxy group (1a/1b, 2a and 2b) Additionally, HRMS² analysis of deepoxy-DON did not reveal the presence of an m/z 138.0311 fragment The foregoing information suggests that the formation of the m/z 138 fragment ion is associated with the presence of an intact 12,13-epoxy group, and 1e and 1f are thus suspected to be Michael adducts of mercaptoethanol at C-10 of DON. Another diagnostic feature that may assist in distinguishing between a Michael-addition product and a reaction product from mono-addition of mercaptoethanol to the epoxy group is the presence of an m/z 343.1228 product ion (C₁₆H₂₃O₆S⁻, Δ 2.9 ppm) in the LC-HRMS² spectra of the epoxide-conjugates. These ions are formed by loss of formate and of CH₂O, presumably from the C-6 position of the molecular ion. In the LC-MSⁿ spectra, fragmentation of m/z 343 (MS⁴) afforded m/z (loss of 78 Da, corresponding to the mass of mercaptoethanol), m/z 247 (additional loss of H₂O), and m/z 229 (further loss of H₂O). Formation of m/z 265 ion could occur via creation of a bond between the 7-OH group and C-13 during the mercaptoethanol elimination to form a new, six-membered ring.

Cellular Effects.

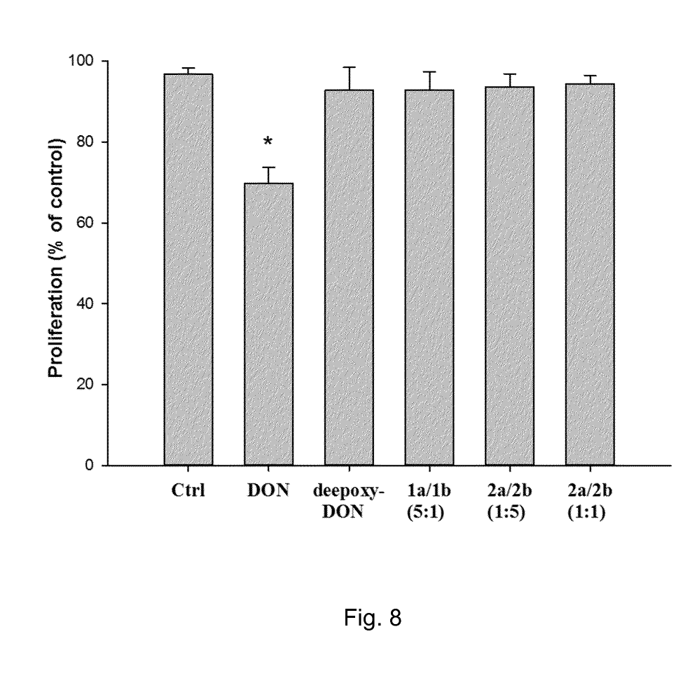

As with other trichothecenes, DON is able to cause cellular effects, such as inflammation and toxicity, through its ability to target ribosomes and to cause ribotoxic stress. (Toxins (Basel) 2013, 5, 784-820) Because deepoxy-DON does not affect ribosomes, it has been proposed that the 12,13-epoxy group is critical for their action on ribosomes. (Toxins (Basel) 2013, 5, 784-820). To compare the effects of DON, deepoxy-DON and mercaptoethanol derivatives 1a/1b and 2a/2b on proliferation of THP-1 monocytes we used the Alamar Blue assay. THP-1 cells were treated with 4 μM DON, deepoxy-DON and purified mixtures of 1a/1b, and 2a/2b for 24 h. As shown in FIG. 8, DON decreased the proliferation of THP-1 monocytes, but deepoxy-DON and DON-mercaptoethanol-adducts 1a/1b and 2a/2b did not. These results indicate that the epoxide moiety has the most significant role in the toxicity of DON.

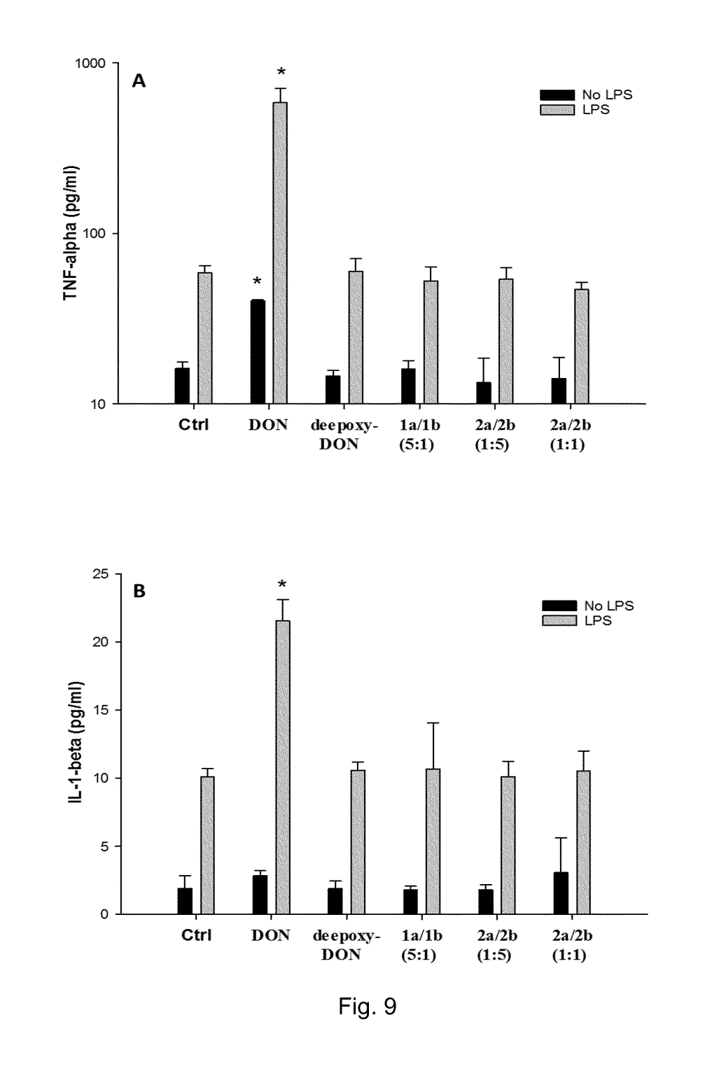

DON induces expression of several pro-inflammatory cytokines, such as TNFα, IL-1b, IL-6 and IL-8 (Toxicol. Lett. 2013, 217, 149-58), and pre-treatment (i.e., priming) with lipopolysaccaride (LPS) potentiates the induction of pro-inflammatory cytokine expression by DON (Toxicol. Appl. Pharmacol. 2006, 211, 53-63), (Toxicol. Sci. 2006, 92, 445-55). To examine pro-inflamatory responses induced by DON, deepoxy-DON and mercaptoethanol derivatives 1a/1b and 2a/2b, we analyzed the levels of TNF-α and IL-1β secretion produced by PMA-differentiated macrophages, with and without LPS priming. Regardless of the absence or the presence of the LPS, there was an increase in TNF-α in response to DON, but not to any of the derivatives (FIG. 9, graph A.), although the sensitivity was higher with LPS present. Similarly, DON increased the release of IL-1β in LPS-primed cells whereas deepoxy-DON, 1a/1b and 2a/2b did not (FIG. 9, graph B), although cells that were not treated with LPS did not show an IL-1β response to any of the compounds, including DON.

Thus, DON, but not deepoxy-DON nor mercaptoethanol derivatives 1a/1b and 2a/2b, reduced proliferation of THP-1 monocytes, and induced pro-inflammatory responses in PMA-differensiated LPS-primed THP-1 macrophages. The lack of toxic responses to a/1b and 2a/2b (both of which involve derivatization of the 12,13-epoxy group of DON) supports the involvement of the epoxy-group in the toxicity of trichothecenes—a hypothesis hitherto based solely on observations with deepoxy-DON. While all the mecaptoethanol adducts isolated in the present study were derivatized at C-13 of the epoxy group of DON and were non-toxic, a previous study has also demonstrated reduced toxicity for Michael addition products of methane thiol with DON (J. Agric. Food. Chem. 2013, 61, 8941-8, (J. Agric. Food. Chem. 2013, 61, 8941-8.).

Effect of pH on Reaction Rate.

DON and mercaptoethanol were reacted at pH 7.3, 9.2 and 10.7, and monitored by LC-MS (Procedure 1). Neither DON nor mercaptoethanol contain acidic or basic groups, so DON and its mercaptoethanol derivatives can be expected to have similar responses in LC-MS. This makes it possible to estimate the proportions of DON and its reaction products by integrating areas under the peaks in the LC-MS chromatograms. We used a large excess of the thiol (ca 20-fold) and treated the reaction as a pseudo first-order, assuming peak areas were proportional to the concentrations, and followed the depletion of DON by plotting natural logarithm of the relative peak area over time (FIG. 6). However, the reaction kinetics are expected to be more complex, with several reversible reaction equilibria (Michael addition of the thiol to the double bond and hemiketal-ketone exchange) (Scheme 1). Furthermore, autoxidation of the thiol to form the disulphide can be expected to reduce the thiol concentration over time. Therefore, the reaction of DON with mercaptoethanol only displayed first-order kinetics for the first few hours. Nevertheless, a dramatic increase in reaction rate occurred when the pH was increased from 7.2 to 9.2, with a further modest increase in rate when the pH was increased further to 10.7 (FIG. 6). These observations support nucleophilic attack by the thiolate ion as the dominant reaction mechanism, as the pKₐ of mercaptoethanol is ca 9.6. Regardless of the pH, there was always the same progression in the formation of the reaction products, and even at physiological pH adducts 1e and 1f appeared first. Attack of thiolate on the 12,13-epoxy group is expected to be essentially irreversible, while thiolate attack on C-10 of DON (Michael addition) should be reversible. In contrast, attack of thiolate on the isolated double bond in DON-hemiketal is not expected, and isomerization of the thia-Michael addition products of DON to their hemiketal forms should hinder the elimination of thiol from C-10. The reaction scheme shown in Scheme 1 thus accounts for the products identified in the reaction and, together with the well-known autoxidation of thiols to disulfides, for the presence of only epoxy-adducts 1a and 1b at extended reaction times. The late eluting broad peak in the LC-MS may be due to on-column ketone-hemiketal isomerization, as this peak partially resolved when the mercaptoethanol addition products of DON were analysed without the presence of formic acid in the mobile phase.

The above experiments provide evidence that DON and other trichothecenes react with thiolate ions of a range of natural and unnatural thiols via Michael addition to C-10 of the α,β-unsaturated ketone and addition to C-13 of the 12,13-epoxy group, where these functional groups are present. These reactions occur rapidly at elevated pH, but the reaction rate is measurable even at physiological pH. The reactions were conducted in the absence of enzymatic catalysis. Two derivatives of DON with mercaptoethanol adducted to C-13 of the epoxy group were tested, and showed no signs of toxicity in vitro.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

Unless expressly described to the contrary, each of the preferred features described herein can be used in combination with any and all of the other herein described preferred features.

### REFERENCES

Appl. Microbiol. Biotechnol., August 2011, 91(3), 491-504.
Foster et al. “A Possible Enzymatic Assay for Trichothecene Mycotoxins in Animal Feedstuffs”, Biochemical Society Transactions, 1 Jan. 1975, pages 875-878.
Gardiner et al. Transcriptome Analysis of the Barley-Deoxynivalenol Interaction: Evidence fora Role of Glutathione in Deoxynivalenol Detoxification”, Molecular Plant-microbe Interactions, vol. 23, no. 7, 2010, p. 962-976.
Frumann et al. Org. Biomol. Chem., 2014, 12, 5144-5150

1. A method for detoxification of a trichothecene contaminated sample, said method comprising the steps of:
a) mixing said trichothecene contaminated sample, a thiol containing compound, and an aqueous solution thereby providing a reaction mixture;
wherein said reaction mixture has a pH that is equal to or higher than one pH unit less than the pKa of a thiol group of said thiol containing compound;
b) allowing the reaction to proceed.

2. The method according to claim 1, wherein said trichothecene is a type A trichothecene, a type B trichothecene, a type C trichothecene and/or a type D trichothecene.

3. The method according to claim 1 or 2, wherein said trichothecene is a type A trichothecene and/or a type B trichothecene,

4. The method according to claim 3, wherein said type A trichothecene and/or type B trichothecene is deoxynivelanol, nivelanol, T-2 toxin and/or HT-2 toxin.

5. The method according to any one of the preceding claims, wherein said trichothecene is deoxynivelanol.

6. The method according to any one of the preceding claims, wherein the thiol containing compound is selected so that a thiol group of said thiol containing compound has a pKa within the range of from 6.5 to 10, such as from 7 to 10 or such as from 8 to 10.

7. The method according to any one of the preceding claims, wherein said thiol containing compound is selected so that a thiol group of said thiol containing compound has a pKa within the range of from 8 to 10.

8. The method according any one of the preceding claims, wherein said thiol containing compound is selected from the group consisting of hydrogen sulphide, methane thiol, mercaptoethanol, cysteine, aminoethanethiol, thioethanesulfonate, glutathione and any combinations thereof.

9. The method according any one of the preceding claims, wherein said thiol containing compound is selected from the group consisting of mercaptoethanol, cysteine, aminoethanethiol, thioethanesulfonate, glutathione and any combinations thereof.

10. The method according any one of the preceding claims, wherein said thiol containing compound is selected from the group consisting of hydrogen sulphide, cysteine, glutathione and any combinations thereof.

11. The method according to any one of the preceding claims, wherein said method comprises epoxide ring opening of said trichothecene.

12. The method according to any one of the preceding claims, wherein said method comprises Michael addition of the thiol containing compound to the conjugated double bond of the trichothecene.

13. The method according to any one of the preceding claims, wherein said aqueous solution is selected to provide acidic, neutral or alkaline conditions.

14. The method according to any one of the preceding claims, wherein said aqueous solution is selected to provide alkaline conditions.

15. The method according to claim 14, wherein said alkaline conditions are provided by a strong base or a weak base.

16. The method according to claim 15, wherein said strong base comprises hydroxide ions.

17. The method according to claim 15 or 16, wherein said strong base is selected from the group consisting of sodium hydroxide, potassium hydroxide, ammonium hydroxide and any combinations thereof.

18. The method according to claim 15, wherein said weak base is selected from the group consisting of carbonates, borates, amines and any combinations thereof.

19. The method according to any one of the preceding claims, wherein said method is performed at a pH of about 6 or above, such as 8 or above, such as at a pH range from about 8 to about 11.5 or from about 10 to about 11.

20. The method according to any one of the preceding claims, wherein said method is performed at a pH of about 8 or above, such as a pH range from about 8 to about 11.5 or from about 10 to about 11.

21. The method according to any one of the preceding claims, wherein said reaction mixture has a pH of about 6 or above, such as 8 or above, such as a pH range from about 8 to about 11.5 or from about 10 to about 11.

22. The method according to any one of the preceding claims, wherein said reaction mixture has a pH of 8 or above, such as a pH range from about 8 to about 11.5 or from about 10 to about 11.

23. The method according to any one of the preceding claims, wherein said aqueous solution has a pH of about 6 or above, such as 8 or above, such as a pH range from about 8 to about 11.5 or from about 10 to about 11.

24. The method according to any one of the preceding claims, wherein said aqueous solution has a pH of about 8 or above, such as a pH range from about 8 to about 11.5 or from about 10 to about 11.

25. The method according to any one of the preceding claims, wherein the reaction is allowed to proceed at a temperature of about 0° C. to about 85° C., such about from 30° C. to about 85° C.

26. The method according to any one of the preceding claims, wherein the reaction is allowed to proceed at room temperature.

27. The method according to any one of the preceding claims, wherein the reaction is allowed to proceed at temperatures commonly employed in food and/or feed production and/or storage.

28. The method according to any one of the preceding claims, wherein said aqueous solution comprises an organic solvent.

29. The method according to claim 28, wherein the organic solvent is water miscible.

30. The method according to claim 28 or 29, wherein said organic solvent is an alcohol such as ethanol.

31. The method according to any one of the preceding claims, wherein the step of allowing the reaction to proceed takes place under inert atmosphere.

32. The method according to claim 31, wherein the inert atmosphere is provided by nitrogen, argon, carbon dioxide or mixtures thereof.

33. The method according to any one of the preceding claims, wherein the step a) and/or step b) takes place in the presence of a disulphide formation inhibitor.

34. The method according to any one of the preceding claims further comprising a step of isolating a detoxified trichothecene contaminated sample.

35. The method according to any one of the preceding claims, further comprising a step of storing the detoxified type trichothecene contaminated sample.

36. The method according to claim 35, wherein the step of storing the detoxified type trichothecene contaminated sample comprises reaction of the thiol containing compound with the trichothecene contaminated sample.

37. The method according to any one of the preceding claims, wherein said method is a preparative method.

38. The method according to any one of claims 1-36, wherein said method is an industrial method.

39. The method according to any one of the preceding claims, wherein the mixing of said trichothecene contaminated sample, the thiol containing compound, and the aqueous solution in step a) takes place in any order.

40. The method according to any one of the preceding claims, wherein step a) takes place by mixing the aqueous solution and the thiol containing compound thereby providing a mixture, and then applying this mixture to the trichothecene contaminated sample.

41. The method according to any one of claims 1-39, wherein step a) takes place by addition of the thiol containing compound to a mixture of the trichothecene contaminated sample and the aqueous solution.

42. The method according to any one of claims 1-39, wherein step a) takes place by addition of the aqueous solution to a mixture of the thiol containing compound and the trichothecene contaminated sample.

43. The method according to any one of claims 1-39, wherein the thiol containing compound is contained within the trichothecene contaminated sample.

44. The method according to any one of the preceding claims, further comprising addition of a thiol containing compound to the trichothecene contaminated sample.

45. The method according to any one of the preceding claims, wherein the added thiol compound is the same and/or different from a thiol containing compound contained within the trichothecene contaminated sample.

46. The method according to any one of the previous claims, wherein is the reaction is allowed to proceed for from about 1 hour to one month, from about 4 days to about 7 days, or from one day to one month.

47. The method according to any one of the preceding claims, wherein the reaction is allowed to proceed for from about 4 days to one month.

48. The method according to any one of the preceding claims, wherein said trichothecene contaminated sample is hay or straw, grains or seeds, flour and other milled products, and/or livestock or fish feed.

49. The method according to any one of the preceding claims, wherein said trichothecene contaminated sample is a grain-derived or grain-containing product, such as grain intended for food or feed production.

50. The method according to claim 49, wherein the grain-derived or grain-containing product is a food product or feed product.

51. A method according to any one of the preceding claims, wherein the method is a non-enzymatic method.

52. A product obtainable by a method according to any one of the preceding claims.

53. Use of a thiol containing compound for detoxification of a trichothecene contaminated sample by epoxide ring opening of said trichothecene.

54. Use according to claim 53, wherein said trichothecene contaminated sample is a type A trichothecene contaminated sample, a type B trichothecene contaminated sample, a type C trichothecene contaminated sample and/or a type D trichothecene contaminated sample.

55. Use according to claim 53 or 54, wherein the trichothecene contaminated sample is a type A trichothecene contaminated sample and/or a type B trichothecene contaminated sample.
